(19) United States
(12) Patent Application Publication
(10) Pub. No.: US 2024/0283341 A1
(43) Pub. Date: Aug. 22, 2024

(54) SYNCHRONOUS-RELUCTANCE, ROTARY MOTOR-GENERATOR

(71) Applicant: BHE Turbomachinery, LLC, Portland, OR (US)

(72) Inventors: Barry T. Brinks, Fort Collins, CO (US); Henry K. Obermeyer, Wellington, CO (US)

(21) Appl. No.: 18/582,588

(22) Filed: Feb. 20, 2024

Related U.S. Application Data
(60) Provisional application No. 63/446,769, filed on Feb. 17, 2023.

(51) Int. Cl. H02K 21/16

(52) U.S. Cl. CPC H02K 21/16

(57) ABSTRACT

A synchronous-reluctance, rotary motor-generator having a rotor, a stator, a radial air gap positioned radially between the stator and the rotor, and a conductor winding assembly. The rotor has an even number of crescent rotor poles with a gap between adjacent crescent rotor poles. Each crescent rotor pole is non-symmetric about a radially-oriented centerline of the rotor ferromagnetic flux path. Each low-reluctance direct axis of the rotor passes through at least one of the gaps between the crescent rotor poles. Each crescent rotor pole is positioned tangentially to the radial air gap. The stator is on a common center with the rotor. The stator has a stator salient pole between each coil winding slot and positioned tangentially to the radial air gap. Each stator salient pole is non-symmetric about a radially-oriented centerline of the stator-salient-pole.

### CROSS-REFERENCES TO RELATED APPLICATIONS

This patent application claims the benefit of provisional Application No. 63/446,769 filed Feb. 17, 2023, which is incorporated into the present disclosure by this reference.

### TECHNICAL FIELD

The subject matter is related to an apparatus and methods for synchronous- reluctance motor-generators.

### BACKGROUND

High efficiency, high-power density, and high-power-factor rotating electric machines that operate as motors to convert electrical power into rotating mechanical power and also operate as generators to convert rotating mechanical power into electrical power are becoming increasingly important to modern society. Most electricity is generated by, and most electricity is consumed by, rotating electric machines.

Reduction in carbon emissions increasingly requires energy storage to provide continuous electrical grid power levels while being supplied by intermittent generation sources such as wind and solar power. Pumped-hydro is currently the dominant energy storage method for grid electrical energy where two water reservoirs at different elevations are connected by a passage that contains a turbine connected to a motor-generator. The combined efficiency for the pumping and the generating cycles is important to minimize wasted energy where this wasted energy is lost from the grid and, furthermore, the wasted energy reduces the net energy storage capacity for a given pumped-hydro storage system.

The efficiency of the motor-generator is a major contributor to the overall system efficiency of the pumped-hydro system.

Using a motor-generator connected to a turbomachinery impeller, the rotational direction is reversed for the motor-generator operating as a motor to pump water to the upper reservoir relative to the motor-generator operating as a generator as water passes through the turbine to the lower reservoir. Although the direction of rotation for pumping is reverse to the direction of rotation for generating, the direction of motor-generator shaft torque remains constant for both pumping and generating.

For a motor-generator that has symmetric lamination geometry and that is working under a given torque load, the magnetic flux density distribution is not locally symmetric in both the stator and the rotor about any radial axis from the centerline of the motor-generator. Configurations of the disclosed technology address shortcomings in the prior art.

### BRIEF DESCRIPTION OF THE DRAWINGS

Note that the drawings are not to scale. As on example, the radial air gap is shown much larger than scale to illustrate the rotor, the stator, and the radial air gap.

FIG. 1 is a sectional end view of a non-gap-pole, non-symmetric, external-rotor, synchronous-reluctance motor-generator, according to an example configuration of the disclosed technology.

FIG. 2 is a sectional end view of a non-gap-pole, non-symmetric, internal-rotor, synchronous-reluctance motor-generator, according to an example configuration of the disclosed technology.

FIG. 3 is an isometric view of an example gap-pole, non-symmetric, external-rotor, synchronous reluctance motor-generator, according to an example configuration of the disclosed technology.

FIG. 4 is a sectional end view of the motor-generator of FIG. 3.

FIG. 5 is a sectional end view of an example motor-generator that is similar to the motor-generator of FIG. 3, except that is has four crescent rotor poles instead of the six illustrated in FIG. 3.

FIG. 6 is a sectional end view of an example motor-generator that is similar to the motor-generator of FIG. 3, except that is has two crescent rotor poles instead of the six illustrated in FIG. 3.

FIG. 7 is an isometric view of an example gap-pole, non-symmetric, internal-rotor, synchronous-reluctance motor-generator, according to an example configuration of the disclosed technology.

FIG. 8 is a sectional end view of the motor-generator of FIG. 7.

FIG. 9 is a sectional end view of an example motor-generator that is similar to the motor-generator of FIG. 7, except that is has four crescent rotor poles instead of the six illustrated in FIG. 7.

FIG. 10 is a sectional end view of an example motor-generator that is similar to the motor-generator of FIG. 7, except that is has two crescent rotor poles instead of the six illustrated in FIG. 7.

FIG. 11 is an isometric view of an axial, gap-pole, synchronous-reluctance motor-generator, according to an example configuration of the disclosed technology.

FIG. 12 is an isometric view of integral rotor lamination stacks that do not have any attached non-ferromagnetic laminations.

FIG. 13 is a data plot showing output torque related data for internal and external rotor gap-pole, synchronous-reluctance, motor-generators as may appear in at least one embodiment of the disclosed technology.

FIG. 14 is a side section view of a rotor lamination stack for a gap-pole, synchronous-reluctance, rotary motor-generators showing separate blocks of laminations.

FIG. 15 is an isometric view of a rotor lamination stack for a gap-pole, synchronous-reluctance, rotary motor-generators.

FIG. 16 is a flux density contour plot of Finite Element Analysis results for a non-symmetric salient and crescent poles, internal rotor, non-gap-pole, synchronous-reluctance, motor-generator as may appear in at least one embodiment of the disclosed technology.

FIG. 17 is a flux density contour plot of Finite Element Analysis results for a non-symmetric, external rotor, gap-pole, synchronous-reluctance, motor-generator as may appear in at least one embodiment of the disclosed technology.

FIG. 18a is an isometric view of an example rotor assembly. FIG. 18b is a sectional view of a portion of the rotor assembly of FIG. 18a, taken along the line indicated in FIG. 18c. FIG. 18c shows a top view of the rotor assembly of FIG. 18a but without the flat, circular end plate. FIG. 18d is an isometric view of an example tabbed crescent-rotor-pole in isolation. FIG. 18e is an isometric view of an example non-tabbed crescent-rotor-pole in isolation.

FIG. 19a is an isometric view of a two-pole gap-pole rotor assembly, according to an example configuration. FIG. 19b is an isometric view of a four-pole gap-pole rotor assembly, according to an example configuration. FIG. 19c is a magnetic flux plot of the two-pole gap-pole rotor assembly of FIG. 19a.

FIG. 20a is a sectional end view of an example gap-pole, non-symmetric, internal rotor, axial magnet motor-generator, which is similar to what is illustrated in FIG. 9.

FIG. 20b is a sectional end view of an example gap-pole, symmetric, internal rotor, axial magnet motor-generator having symmetrical stator salient poles and crescent rotor poles.

FIG. 21 is an isometric view of an example gap-pole, symmetric, internal rotor, motor-generator rotor with conductive bars.

### DETAILED DESCRIPTION

As described in this document, aspects are directed to a synchronous-reluctance motor-generator that is non-symmetric, where the non-symmetry may be in one or both of the rotor profile geometry and the stator profile geometry.

This non-symmetrical lamination profile adds ferromagnetic material in locations of higher flux density and removes ferromagnetic material in locations of low flux density for a single given torque direction. This non-symmetric motor-generator ferromagnetic lamination design also may be appropriate for use on any synchronous reluctance motor or generator that drives a bidirectional torque load with consistently higher torque loads in one rotational direction than the other rotational direction or for an installation that spends a majority of the operating time with a single given direction torque where the reverse torque operation occurs only over a short time duration duty cycle and, thus, allowing short term increased current to provide full reverse load torque. Configurations of the disclosed technology achieve improvements in efficiency, power density and/or power factor compared with conventional technologies.

Additionally, a non-gap-pole, synchronous-reluctance, rotary motor-generator may provide benefits when using a non-symmetric rotor. In such configurations, the stator ferromagnetic profile geometry is able to produce more torque in one given circumferential direction relative to using a symmetric profile geometry.

Aspects are also directed to a synchronous-reluctance motor-generator where the rotor low reluctance pole locations occur at the pole-gaps between adjacent ferromagnetic laminations of the rotor.

In some installations the allowable envelope for the motor-generator is limited. In these installations the increased power density of the gap-pole, synchronous-reluctance, rotary motor-generator allows for a higher power rated motor-generator to be installed resulting in an increased available rotor torque vs. motor load or vs. generator load. This helps to avoid shutdown during a very brief grid power interruption. The power density of the gap-pole, synchronous-reluctance rotary motor-generator increases at lower rotor pole quantities, providing a higher operating speed for a given grid frequency or other supply excitation frequency. The use of higher speed provides more stored kinetic energy in the motor-generator rotor and, for a given load power level, helps to avoid shutdown during a very brief grid power interruption or a very brief overload condition. The increased power density of configurations disclosed in this document reduces the motor-generator raw material volume and allows for a lower motor-generator fabrication cost.

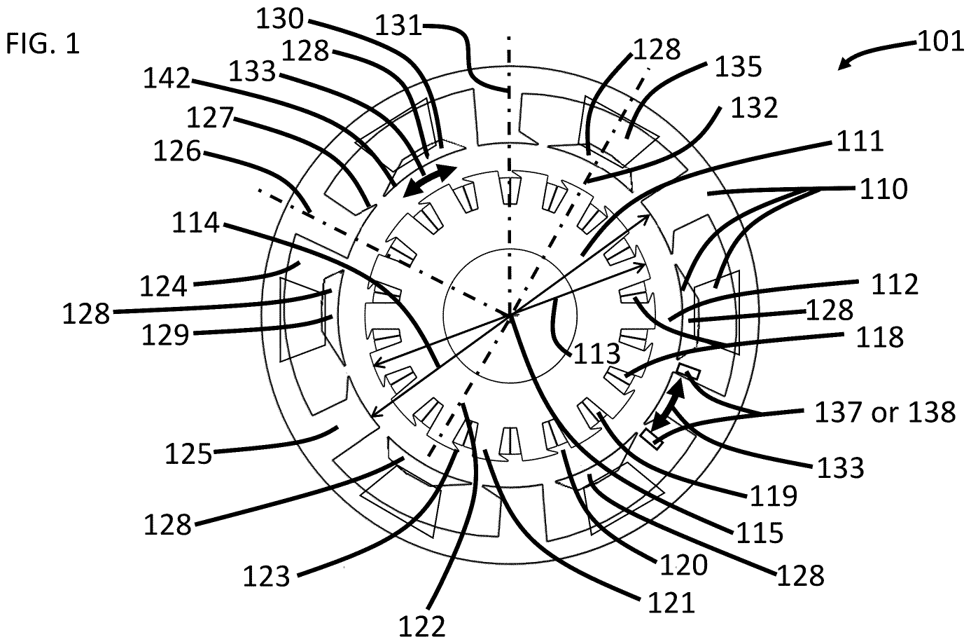

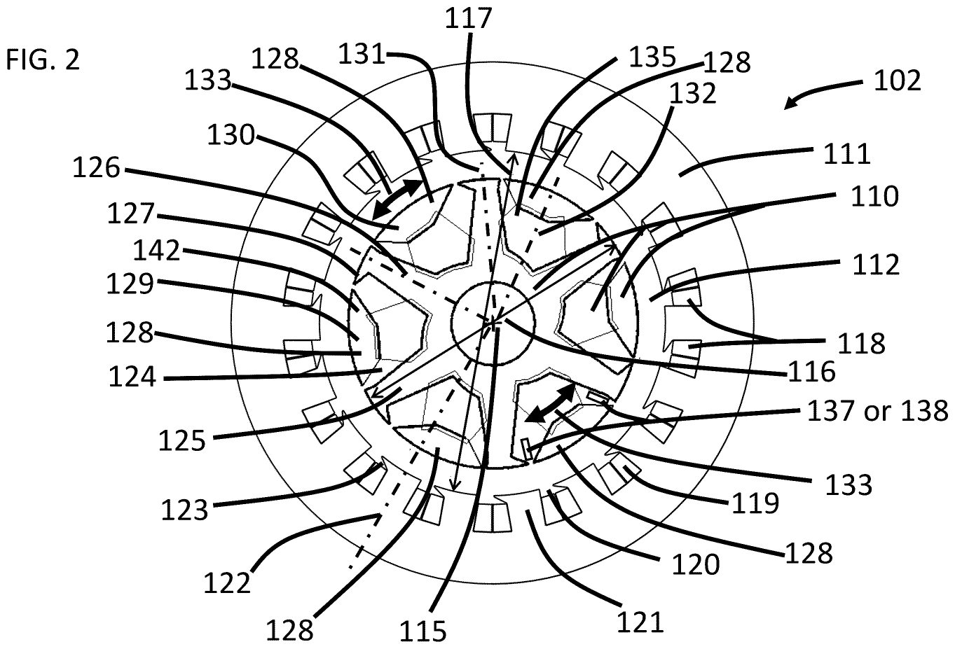

FIG. 1 is a cross section view showing portions of a non-gap-pole, non-symmetric, synchronous-reluctance motor-generator according to an example configuration. As illustrated in FIG. 1, configurations of a non-gap-pole, non-symmetric, synchronous-reluctance rotary motor-generator 101 include a rotor 110 that is radially external to a stator 111. Accordingly, the stator 111 is radially inside of the rotor 110. FIG. 2 is a cross section view showing portions of a non-gap-pole, non-symmetric, synchronous-reluctance motor-generator according to an example configuration. As illustrated in FIG. 2, configurations of a non-gap-pole, non-symmetric, synchronous-reluctance rotary motor-generator 102 include a stator 111 that is radially external to a rotor 110.

Given the similarities between the rotary motor-generator 101 of FIG. 1 (having an external rotor) and the rotary motor-generator 102 of FIG. 2 (having an internal rotor), both configurations are described together in the discussion that follows.

As illustrated in FIGS. 1 and 2, each of the rotor 110 and the stator 111 has a volume envelope that is substantially cylindrical. As used in this disclosure, “substantially cylindrical” means largely or essentially having the form of a right circular cylinder without requiring perfect cylindricality. A radial air gap 112, which is substantially cylindrical, is radially between the stator 111 and the rotor 110. For configurations where the stator 111 is radially inside of the rotor 110 (such as shown in FIG. 1), the outside diameter 113 of the stator 111 and the inside diameter 114 of the rotor 110 are on a common center 115. For configurations where the rotor 110 is radially inside of the stator 111 (such as shown in FIG. 2), the outside diameter 116 of the rotor 110 and the inside diameter 117 of the stator 111 are on a common center 115.

The stator 111 is largely made of ferromagnetic laminations. Ferromagnetic laminations are typically made from materials such as non-grain-oriented silicon iron, grain-oriented silicon iron, iron, 430 stainless steel, and amorphous magnetic alloys. Some materials might be heat treated, including by annealing. In configurations, the stator laminations may be stacked with a small helix angle or other similar methods to reduce the torque ripple caused by torque variation at different rotor angles.

The stator 111 holds a conductor winding assembly 118. While the illustrated configuration has three phases, the conductor winding assembly 118 may have three-phases or an arbitrary number of winding phases. The conductor winding assembly 118 includes individual conductor winding coils 119 in coil winding slots 120.

A stator salient pole 121 is between each adjacent pair of coil winding slots 120 and is positioned tangentially to the radial air gap 112. Each stator salient pole 121 has a radially-oriented, stator-salient-pole centerline 122. The stator salient poles 121 may have either symmetrical or non-symmetrical geometry about stator-salient-pole centerline 122.

It is noted that a non-symmetrical geometry has no centerline. Stated another way, the non-symmetrical geometries discussed in this disclosure have no radial lines of symmetry. In configurations, the non-symmetrical geometries discussed in this disclosure have no lines of symmetry at all. As a result, the “centerlines” for the non-symmetrical geometries discussed in this disclosure and illustrated in the drawings are lines that approximately radially bisect the given geometry.

Each of the stator salient poles 121 in FIGS. 1 and 2 is illustrated with non-symmetrical geometry about the stator-salient-pole centerline 122 since, as shown in the drawing, an additional tab 123 extends from one side of the stator salient pole 121 but not the other side. As illustrated in FIG. 1, the tab 123 is a pole tip protrusion on the counterclockwise side of the pole tip, which is absent from the pole tip on the clockwise side of the pole tip. In other configurations, such as shown in FIG. 2, that could be reversed such that the tab 123 is instead on the clockwise side of the stator salient pole 121. For clarity, either of the configurations of FIGS. 1 and 2 could have the tab, or protrusion, 123 on either of the clockwise or the counterclockwise side of the stator salient pole 121. Other techniques could also be used to make the stator salient pole 121 non-symmetrical about the stator-salient-pole centerline 122.

Hence, the non-symmetrical stator salient pole 121 has no radial lines of symmetry. In some configurations, the non-symmetrical stator salient pole 121 has no lines of symmetry at all.

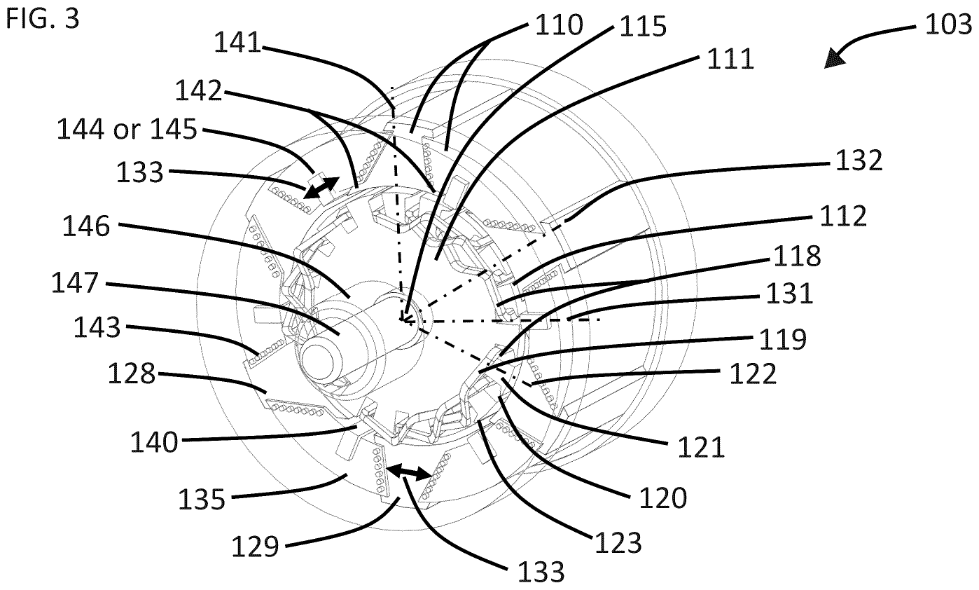

The number of stator salient poles 121 is typically some multiple of the mathematical product of the number of supply voltage phases and the number of stator electromagnetic poles. For example, FIGS. 1-4 and FIGS. 7 and 8 each have six rotor poles (i.e. six pairs of rotor salient poles and rotor crescent poles for FIGS. 1 and 2 and six crescent rotor poles for FIGS. 3, 4, 7, and 8). Each of those has eighteen stator salient poles, which is three times the rotor pole count. The multiple of three is due to the three-phase voltage supply, and other multiples of three would also work, such as six, nine, twelve, etc.

In the illustrated configuration, the rotor 110 is largely made of ferromagnetic laminations fastened or otherwise affixed to non-ferromagnetic laminations to form a quantity of rotor ferromagnetic poles equal to the number of stator electromagnetic poles. The rotor 110 has an even number of rotor slots 124, with a rotor slot 124 on either side of a rotor salient pole 125 that is positioned tangentially to the radial air gap 112. While the illustrated configuration shows six rotor salient poles 125, other configurations may have more or fewer such poles. Each rotor salient pole 125 has a radially-oriented, rotor-salient-pole centerline 126. The rotor salient pole 125 may have either symmetrical or non-symmetrical geometry about the rotor-salient-pole centerline 126. As noted above, the “centerlines” for the non-symmetrical geometries discussed in this disclosure are lines that approximately radially bisect the given geometry.

Each of the rotor salient poles 125 in FIGS. 1 and 2 are illustrated with non-symmetrical geometry about the rotor-salient-pole centerline 126 since, as shown in the drawing, an additional tab 127 extends from one side of the rotor salient pole 125 but not the other side. Other techniques could also be used to make the rotor salient pole 125 non-symmetrical about the rotor-salient-pole centerline 126.

Hence, the non-symmetrical rotor salient pole 125 has no radial lines of symmetry. In some configurations, the non-symmetrical rotor salient pole 125 has no lines of symmetry at all.

As illustrated, a crescent rotor pole 128 is within each rotor slot 124 and positioned tangentially to the radial air gap 112. These are called “crescent” rotor poles because each provides a crescent-shaped flux path as the magnetic flux lines pass through the crescent rotor poles 128. In the configurations illustrated in FIGS. 1 and 2, each crescent rotor pole 128 is radially thinner near each adjacent rotor salient pole 125 and is radially thicker near the mid-span between the adjacent rotor salient poles 125, thus forming what is referred to here as a crescent shape. Each crescent rotor pole 128 is positioned to span a portion of the circumferential gap between the adjacent rotor salient poles 125.

Each pair of adjacent crescent rotor poles 128 may have either symmetrical or non-symmetrical geometry about the corresponding rotor-salient-pole centerline 126. In this context, “adjacent” means the next one in the motor-generator circumferential direction 133. Each such pair of adjacent crescent rotor poles 128 in FIGS. 1 and 2 are illustrated with non-symmetrical geometry about the rotor-salient-pole centerline 126. By way of explanation, one of the crescent rotor poles 128 is further identified in FIGS. 1 and 2 with reference number 129, while the corresponding crescent rotor pole 128 (across the rotor-salient-pole centerline 126 that is between the adjacent crescent rotor poles 129 and 130) is further identified with reference number 130. As shown in FIGS. 1 and 2, the crescent rotor pole 129 is not the mirror image of the crescent rotor pole 130 across the rotor-salient-pole centerline 126. Accordingly, the illustrated crescent rotor poles 128 are non-symmetrical about the rotor-salient-pole centerline 126. Other techniques could also be used to make adjacent crescent rotor poles 128 non-symmetrical about the rotor-salient-pole centerline 126 between them.

Additionally, each non-symmetrical crescent rotor pole 130, individually, has no radial lines of symmetry. In some configurations, the non-symmetrical crescent rotor pole 130, individually, has no lines of symmetry at all.

It is standard in variable reluctance motors and generators to define a low reluctance rotor Direct (“D”) axis as a location on the rotor where, under zero torque load, the rotor would align with an energized stator pole location. It is also standard to define a high reluctance rotor Quadrature (“Q”) axis at a circumferential location centered between two adjacent rotor D-axis locations. With reference to FIG. 1, the low-reluctance D-axis is identified with reference number 131, and the high-reluctance Q-axis is identified with reference number 132.

Since the rotor low-reluctance D-axis 131 passes through the rotor salient pole 125, the configurations illustrated in FIGS. 1 and 2 are examples of a non-gap-pole configuration.

In configurations, the crescent rotor pole 128 may include a grain-oriented lamination material with the grain direction oriented in the motor-generator circumferential direction 133. As illustrated in FIG. 1, each crescent rotor pole 128 is fastened or otherwise affixed to a non-ferromagnetic crescent-rotor-pole web 135, and each crescent-rotor-pole web 135 is also fastened or otherwise affixed to the rotor 110. A permanent magnet 137, which is magnetized in the motor-generator circumferential direction 133, is in each gap between a given rotor salient pole 125 and the adjacent crescent rotor pole 128 on each side of the rotor salient pole 125. Note that, in FIGS. 1 and 2, example positions of two permanent magnets 137 are illustrated while the remaining permanent magnets 137 are not illustrated to reduce clutter in the drawings. In configurations, adjacent permanent magnets 137 are magnetized in opposite circumferential directions 133.

Accordingly, with reference to FIG. 1, two permanent magnets 137 are illustrated, and they are adjacent because one is in the next closest gap (between a given rotor salient pole 125 and the adjacent crescent rotor pole 128) either clockwise or counterclockwise from the perspective shown in FIG. 1. In configurations, one of these permanent magnets 137 would be magnetized clockwise in the circumferential direction 133 illustrated in FIG. 1, while the other of these permanent magnets 137 would be magnetized counterclockwise in the circumferential direction 133. Alternatively, instead of the permanent magnet 137, an electromagnetic coil 138 may be located in each such gap between the rotor salient pole 125 and the crescent rotor pole 128. In configurations where the magnetization of the permanent magnet 137 or the electromagnetic coil 138 is oriented to point in the opposite circumferential direction 133 of the flux leakage between the adjacent rotor salient pole 125 and the crescent rotor pole 128, the circumferential flux leakage between the rotor salient pole 125 and the crescent rotor pole 128 is reduced.

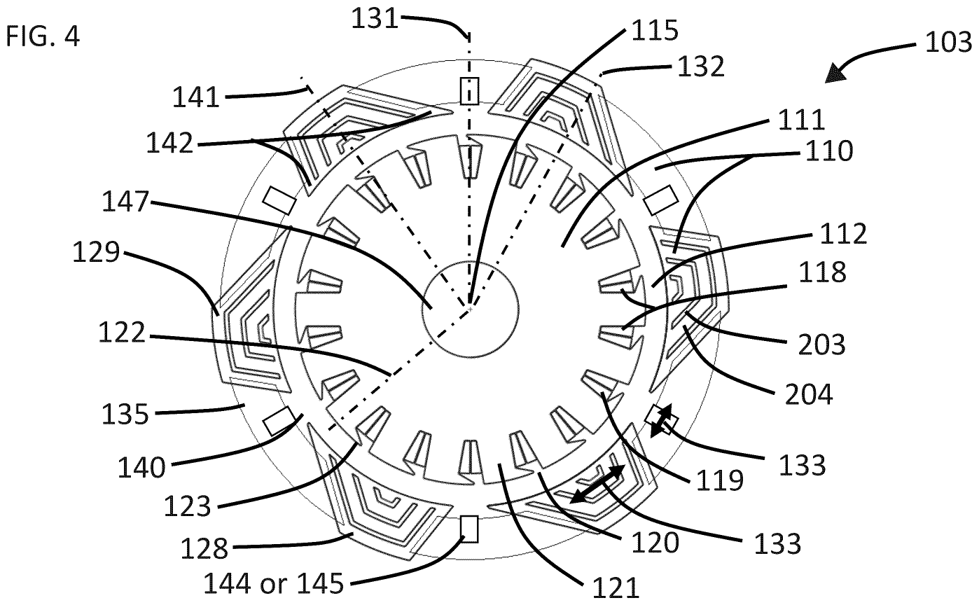

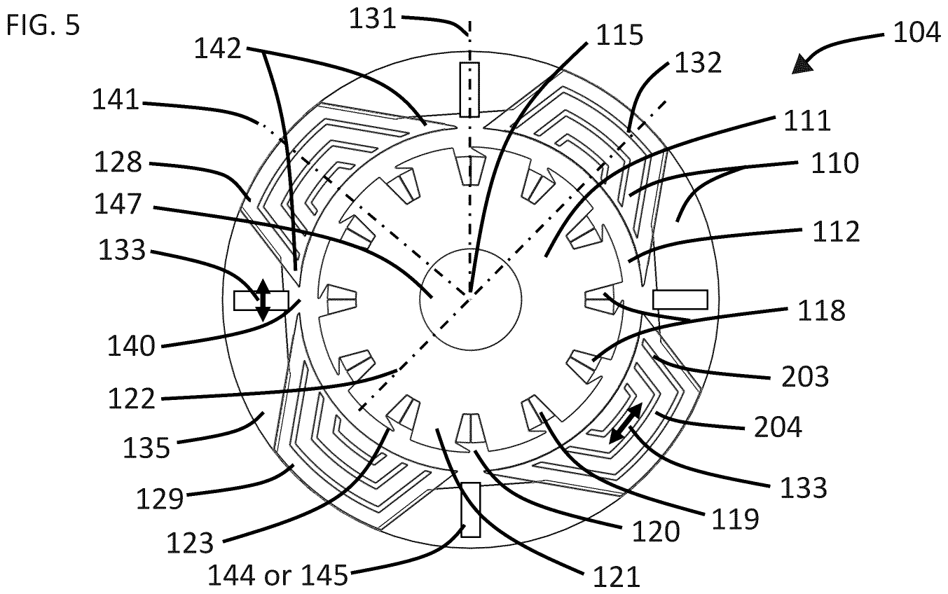

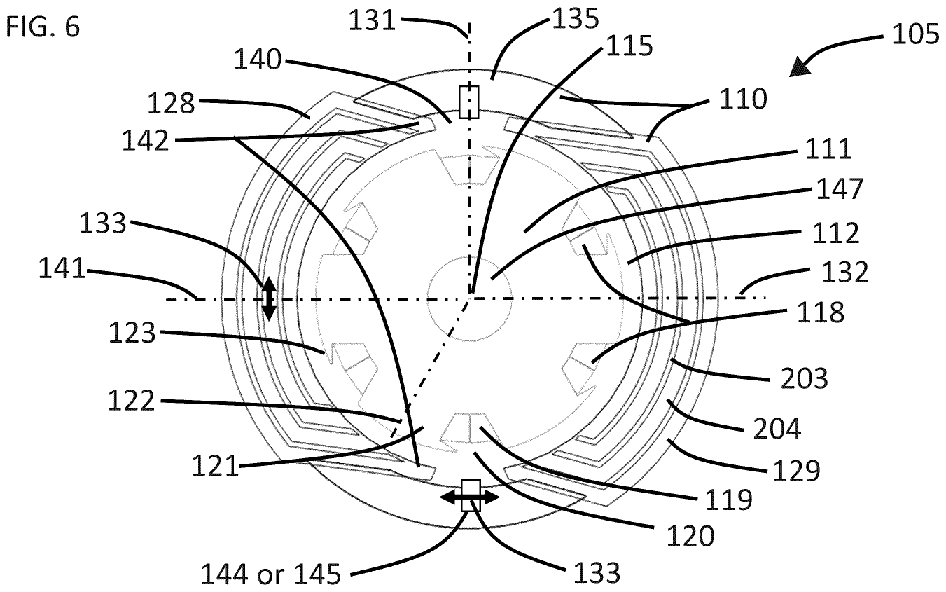

FIG. 3 is an isometric view of a gap-pole, non-symmetric, external-rotor, synchronous reluctance motor-generator 103 according to an example configuration. FIG. 4 is a sectional, end view of the motor-generator 103 of FIG. 3. FIG. 5 is a sectional, end view of an example motor-generator 104 that is similar to the motor-generator 103 of FIG. 3, except that is has four crescent rotor poles instead of the six illustrated in FIG. 3. FIG. 6 is a sectional, end view of an example motor-generator 105 that is similar to the motor-generator 103 of FIG. 3, except that is has two crescent rotor poles instead of the six illustrated in FIG. 3.

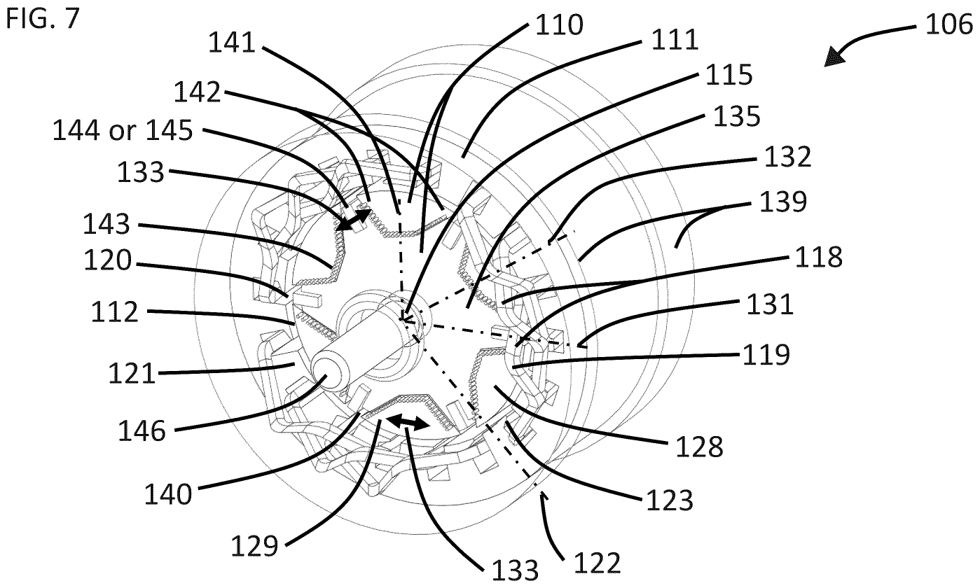

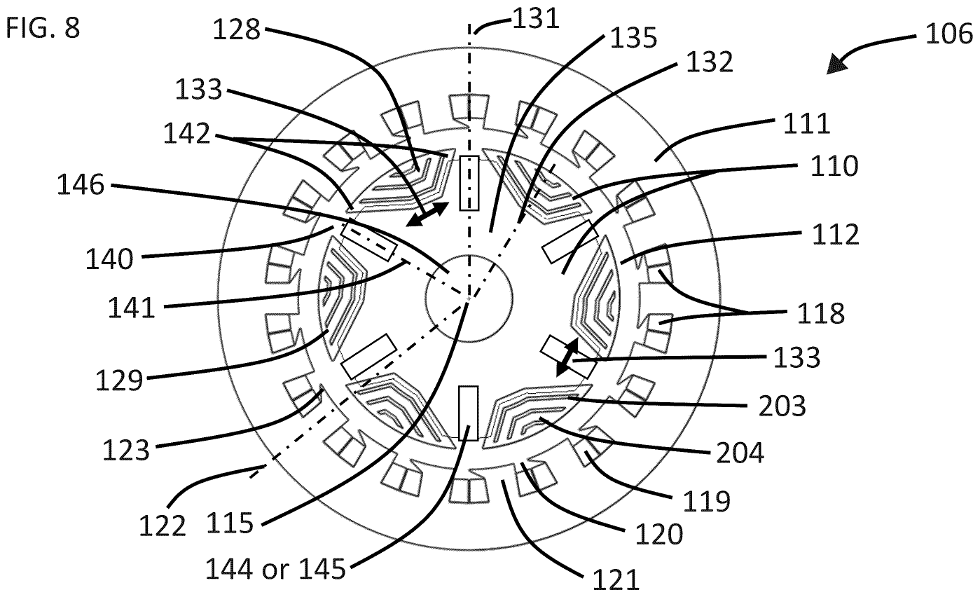

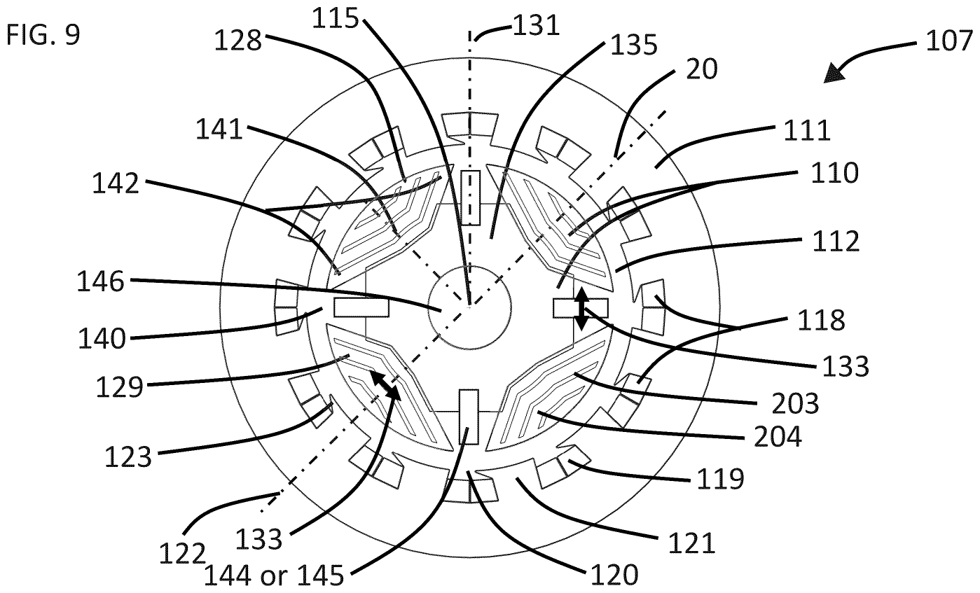

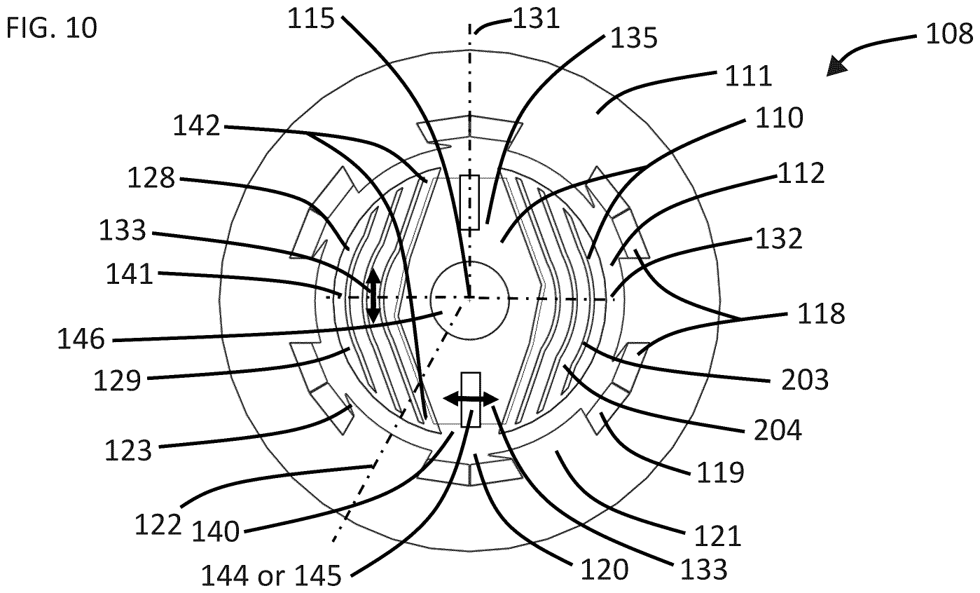

FIG. 7 is an isometric view of a gap-pole, non-symmetric, internal-rotor, synchronous reluctance motor-generator 106 according to an example configuration. FIG. 8 is a sectional, end view of the motor-generator 106 of FIG. 7. FIG. 9 is a sectional, end view of an example motor-generator 107 that is similar to the motor-generator 106 of FIG. 7, except that is has four crescent rotor poles instead of the six illustrated in FIG. 7. FIG. 10 is a sectional, end view of an example motor-generator 108 that is similar to the motor-generator 106 of FIG. 7, except that is has two crescent rotor poles instead of the six illustrated in FIG. 7.

The configurations illustrated in FIGS. 3-6 are the same as what is described above for the external rotor configuration illustrated in FIG. 1 except as noted in the discussion that follows. Additionally, the configurations of FIGS. 5 and 6 are substantially the same as the configuration of FIGS. 3 and 4 except for the number of crescent rotor poles. Hence, the discussion that follows, while expressly referring to the configuration of FIGS. 3 and 4, also applies to FIGS. 5 and 6.

Moreover, the configurations illustrated in FIGS. 7-10 are the same as what is described above for the internal rotor configuration illustrated in FIG. 2 except as noted in the discussion that follows. Additionally, the configurations of FIGS. 9 and 10 are substantially the same as the configuration of FIGS. 7 and 8 except for the number of crescent rotor poles. Hence, the discussion that follows, while expressly referring to the configuration of FIGS. 7 and 8, also applies to FIGS. 9 and 10.

Furthermore, given the similarities between the rotary motor-generator 103 of FIGS. 3 and 4 (having an external rotor) and the rotary motor-generator 106 of FIGS. 7 and 8 (having an internal rotor), both configurations are described together in the discussion that follows.

In particular, and with reference to FIGS. 3 and 7, the rotor 110 does not have the rotor salient poles 125 or the rotor slots 124 of the configurations illustrated in FIGS. 1 and 2.

Instead, the motor-generator 103 of FIG. 3 and the motor-generator 106 of FIG. 7 includes an even number of gaps (six in the example configurations of FIGS. 3 and 7) between adjacent crescent rotor poles 128, each such gap being the location of a gap-pole 140. The rotor low-reluctance D-axis 131 passes through this gap-pole 140. Accordingly, the configurations illustrated in FIGS. 3 and 7 are examples of gap-pole configurations. Centered between adjacent low-reluctance D-axis 131 locations is the high-reluctance Q-axis 132.

Each crescent rotor pole 128 has a radially-oriented centerline 141 of the rotor ferromagnetic flux path. Each crescent rotor pole 128 may have either symmetrical or non-symmetrical geometry about the centerline 141 of the rotor ferromagnetic flux path. As noted above, the “centerlines” for the non-symmetrical geometries discussed in this disclosure are lines that approximately radially bisect the given geometry.

Each of the crescent rotor poles 128 in FIGS. 3 and 7 are illustrated with non-symmetrical geometry about the centerline 141 of the rotor ferromagnetic flux path since, as shown in the drawing an additional tab 142 extends from one side of the crescent rotor pole 128 but not the other side. As illustrated in FIG. 3, the tab 142 is a protrusion on the clockwise side of the crescent rotor pole 128, which is absent from the pole tip on the counterclockwise side of the crescent rotor pole 128. In other configurations, such as shown in FIG. 7, that could be reversed such that the tab 142 is instead on the counterclockwise side of the crescent rotor pole 128. For clarity, either of the configurations of FIGS. 1 and 7 could have the tab, or protrusion, 142 on either of the clockwise or the counterclockwise side of the crescent rotor pole 128. Other techniques could also be used to make the crescent rotor pole 128 non-symmetrical about the centerline 141 of the rotor ferromagnetic flux path.

Hence, the non-symmetrical crescent rotor pole 128 has no radial lines of symmetry. In some configurations, the non-symmetrical crescent rotor pole 128 has no lines of symmetry at all.

In configurations, the crescent rotor pole 128 may include a grain-oriented lamination material with the grain direction oriented in the motor-generator circumferential direction 133. In configurations, each crescent rotor pole 128 includes slots 203 and webs 204. The slots 203 are parallel to the magnetic flux path and can be used to increase the motor torque by having a low magnetic reluctance for a path parallel to the slots 203 and a high magnetic reluctance with a path perpendicular to the slots 203 where the flux must jump the air gaps within the slots 203.

As illustrated in FIGS. 3 and 7, each crescent rotor pole 128 is joined to one or more non-ferromagnetic crescent-rotor-pole webs 135 by, for example, fasteners 143 shown in FIGS. 3 and 7. A permanent magnet 144, which is magnetized in the motor-generator circumferential direction 133, is in each rotor gap-pole 140 location. In configurations, one or more rotor gap-pole 140 locations does not include a permanent magnet 144. Alternatively, instead of the permanent magnet 144, an electromagnetic coil 145 may be located in each rotor gap-pole 140 location. The permanent magnet 144 or the electromagnetic coil 145 are used in a manner to reduce circumferential flux leakage between adjacent crescent rotor poles 128. In configurations where the magnetization of the permanent magnet 144 or the electromagnetic coil 145 is oriented to point in the opposite circumferential direction 133 of the flux leakage between the adjacent crescent rotor poles 128, the circumferential flux leakage between those crescent rotor poles 128 is reduced.

Rotor 110 is fixed to a rotating output shaft 146 that users would connect various devices to depending on the use application. In configurations having an external rotor (for example, FIGS. 3-6), stator 111 is fixed to a non-rotating shaft 147 to prevent stator rotation. In configurations, this non-rotating shaft 147 may have radial clearance between it and the rotating output shaft 146 to provide a conduit for electrical lead wires and cooling fluids between the two shafts.

FIG. 7 illustrates portions of stator end covers 139, which are part of a motor-generator housing assembly. The complete end cover, or end bell, and the remainder of the motor-generator housing assembly are not shown as this would block the view of the components sought to be illustrated.

As noted, the configurations of FIGS. 5 and 6 are substantially the same as the configuration of FIGS. 3 and 4 except for the number of crescent rotor poles. Accordingly, the motor-generator 104 of FIG. 5 is illustrated as having four crescent rotor poles 128. And the motor-generator 105 of FIG. 6 is illustrated as having two crescent rotor poles 128.

Additionally, the configurations of FIGS. 9 and 10 are substantially the same as the configuration of FIGS. 7 and 8 except for the number of crescent rotor poles. Accordingly, the motor-generator 107 of FIG. 9 is illustrated as having four crescent rotor poles 128. And the motor-generator 108 of FIG. 10 is illustrated as having two crescent rotor poles 128.

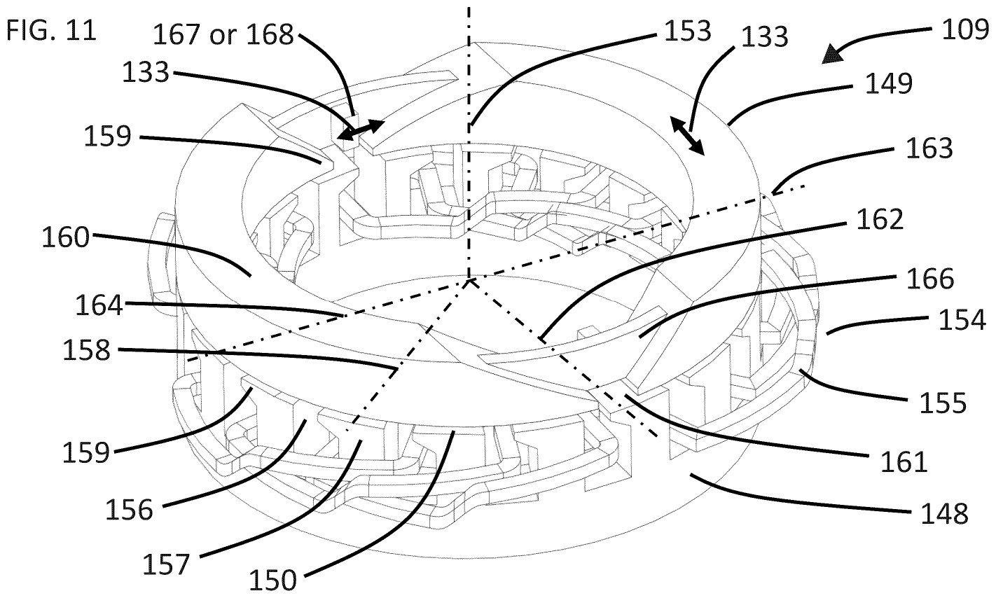

FIG. 11 is an isometric view of an axial, gap-pole, synchronous-reluctance motor-generator, according to an example configuration of the disclosed technology. As illustrated in FIG. 11, configurations of an axial, gap-pole, synchronous-reluctance motor-generator 109 include a stator 148 and a rotor 149, with an axial air gap 150 being axially between the stator 148 and the rotor 149. Each of the rotor 149, the stator 148, and the axial air gap 150 has a volume envelope that is substantially cylindrical, though the volume envelope of the axial air gap 150 is thinner than that of the rotor 149 or the stator 148. As illustrated, the outside diameter of the stator 148 and the outside diameter of the rotor 149 are on a common center 153.

The stator 148 holds a three-phase conductor winding assembly 154. While the illustrated configuration has three phases, the conductor winding assembly 154 may have three-phases or an arbitrary number of winding phases. The conductor winding assembly 154 includes individual conductor winding coils 155 is in or more coil winding slots 156 of a plurality of coil winding slots 156. A stator salient pole 157 is between each adjacent pair of coil winding slots 156 and is positioned adjacent to the axial air gap 150.

Each stator salient pole 157 has a radially-oriented, stator-salient-pole centerline 158. The stator salient poles 157 may have either symmetrical or non-symmetrical geometry about the stator-salient-pole centerline 158. As noted above, the “centerlines” for the non-symmetrical geometries discussed in this disclosure are lines that approximately radially bisect the given geometry.

Each of the stator salient poles 157 in FIG. 11 are illustrated with non-symmetrical geometry about the stator-salient-pole centerline 158 since, as shown in the drawing, an additional tab 159 extends from one side of the stator salient pole 157 but not the other side. Other techniques could also be used to make the stator salient pole 157 non-symmetrical about the stator-salient-pole centerline 158.

Hence, the non-symmetrical stator salient pole 157 has no radial lines of symmetry. In some configurations, the non-symmetrical stator salient pole 157 has no lines of symmetry at all.

The rotor 149 of FIG. 11 does not have any rotor salient poles. Instead, the motor-generator 109 of FIG. 11 includes an even number of gaps (there are two in the example configuration of FIG. 11) between adjacent crescent rotor poles 160, each such gap being the location of a gap-pole 161. Each crescent rotor pole 160 provides a crescent-shaped, ferromagnetic flux path and is positioned adjacent to the axial air gap 150. The rotor low-reluctance D-axis 162 passes through the center of this gap-pole 161. Accordingly, the configuration illustrated in FIG. 11 is an example of a gap-pole configuration. Centered between adjacent low-reluctance D-axis 162 locations is the high-reluctance Q-axis 163.

Each crescent rotor pole 160 has a radially-oriented centerline 164 of the rotor ferromagnetic flux path. Each crescent rotor pole 160 may have either symmetrical or non-symmetrical geometry about centerline 164. As noted above, the “centerlines” for the non-symmetrical geometries discussed in this disclosure are lines that approximately radially bisect the given geometry.

The crescent rotor poles 160 in FIG. 11 are illustrated with non-symmetrical geometry about the centerline 164 since, as shown in the drawing, there is additional material at the end 159 of the crescent rotor poles 160 but not at the opposite end of the same of the crescent rotor poles 160. Other techniques could also be used to make the crescent rotor poles 160 non-symmetrical about the centerline 164.

Hence, the non-symmetrical crescent rotor pole 160 has no radial lines of symmetry. In some configurations, the non-symmetrical crescent rotor pole 160 has no lines of symmetry at all.

In configurations, the crescent rotor pole 160 may include a grain-oriented lamination material with the grain direction oriented in the motor-generator circumferential direction 133. Each crescent rotor pole 160 is fastened or otherwise affixed to two non-ferromagnetic webs 166, one at either end of the crescent rotor pole 160. A permanent magnet 167, which is magnetized in the motor-generator circumferential direction 133, is in each rotor gap-pole 161 location. Alternatively, instead of the permanent magnet 167, an electromagnetic coil 168 may be located in each rotor gap-pole 161 location. The permanent magnet 167 or the electromagnetic coil 168 is used in a manner to reduce circumferential flux leakage between adjacent crescent rotor poles 160. In configurations where the magnetization of the permanent magnet 167 or the electromagnetic coil 168 is oriented to point in the opposite circumferential direction 133 of the flux leakage between the adjacent crescent rotor poles 160, the circumferential flux leakage between those crescent rotor poles 160 is reduced.

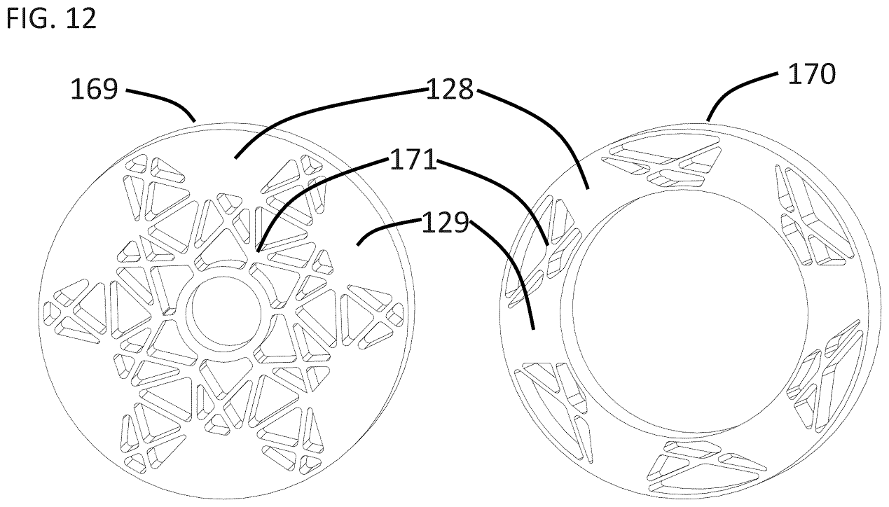

FIG. 12 is an isometric view of integral rotor lamination stacks that do not have any attached non-ferromagnetic laminations. Internal rotor lamination stack 169 and external rotor lamination stack 170 each have a small number of ferromagnetic narrow webs 171 integral to and interconnecting the adjacent crescent rotor poles 128 and 129 into a single-part rotor construction. The single-part internal rotor lamination stack 169 may be used, for example, in place of the rotor assembly of the configuration of FIG. 8. It can also be used, with appropriate modification to account for the number of crescent rotor poles, in the configurations of FIGS. 9 and 10. Likewise, the single-part external rotor lamination stack 170 may be used, for example, in place of the rotor assembly of the configuration of FIG. 4. It can also be used, with appropriate modification to account for the number of crescent rotor poles, in the configurations of FIGS. 5 and 6.

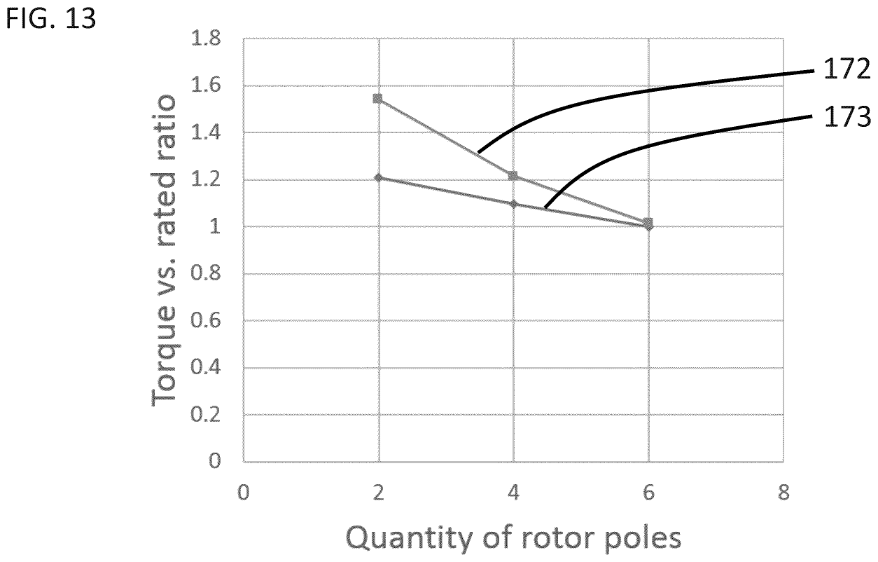

FIG. 13 is a data plot showing the trend lines for identically sized motor-generator design envelope bounding dimensions for external rotor designs (on plot line 172) and internal rotor designs (on plot line 173). This data is plotted normalized to a rated torque based on a single constant power level. The data in FIG. 13 shows increased power density for lower pole counts and also shows a higher power density for the external two-, four-, and six-pole rotor designs for gap-pole, synchronous-reluctance, rotary motor-generators. The large, circumferential, non-ferromagnetic gaps between the crescent rotor poles provides a low level of leakage flux within the rotor. This low leakage flux reduces one source of efficiency loss within the rotor, facilitating a high-power factor and a high efficiency design.

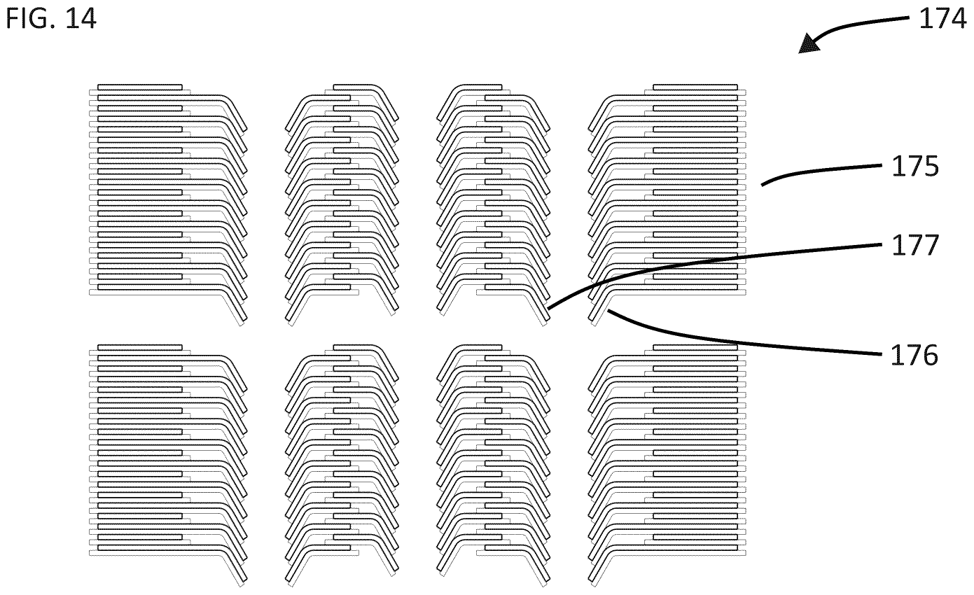

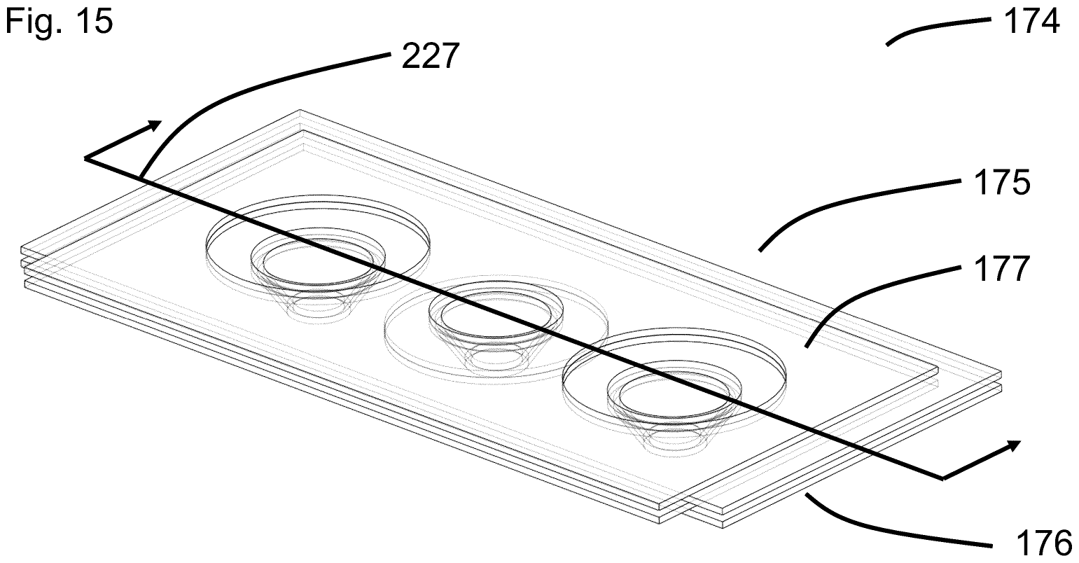

FIG. 14 is a two-dimensional, side, sectional view (taken along the view line 227 shown in FIG. 15) of an example rotor lamination stack 174 for a gap-pole, synchronous-reluctance, rotary motor-generator, showing separate blocks of laminations 175 that are pre-assembled (before final assembly into a motor-generator) to reduce the risk of lamination damage during final assembly. FIG. 15 is an isometric view of the rotor lamination stack 174 of FIG. 14. The thin lines show non-ferromagnetic laminations 176 with a local, deep-drawn plastic deformation out of the lamination plane to nest with a similar indentation in the adjacent lamination and through-holes to clear the indentations on the ferromagnetic laminations 177. The thick lines show ferromagnetic laminations 177 with a local, deep-drawn plastic deformation out of the lamination plane to nest with a similar indentation in the adjacent lamination and through-holes to clear the indentations on the non-ferromagnetic laminations 176. In other words, the deep-drawn plastic deformations in the illustrated configuration allow the non-ferromagnetic laminations 176 and the ferromagnetic laminations 177 to nest together like stacked bowls would nest together.

Stated another way, FIGS. 14 and 15 illustrate of one possible method of constructing a gap-pole, synchronous-reluctance, rotary motor-generator. The rotor needs to have ferromagnetic laminations attached to non-ferromagnetic laminations. The side view of FIG. 14 and the isometric view of FIG. 15 show that the ferromagnetic laminations and non-ferromagnetic laminations can be joined by tightly packing the various laminations, where each lamination has protrusions designed to fit into the protrusions in the adjacent laminations. By axially clamping these lamination stacks each lamination is joined to the adjacent lamination in the stack.

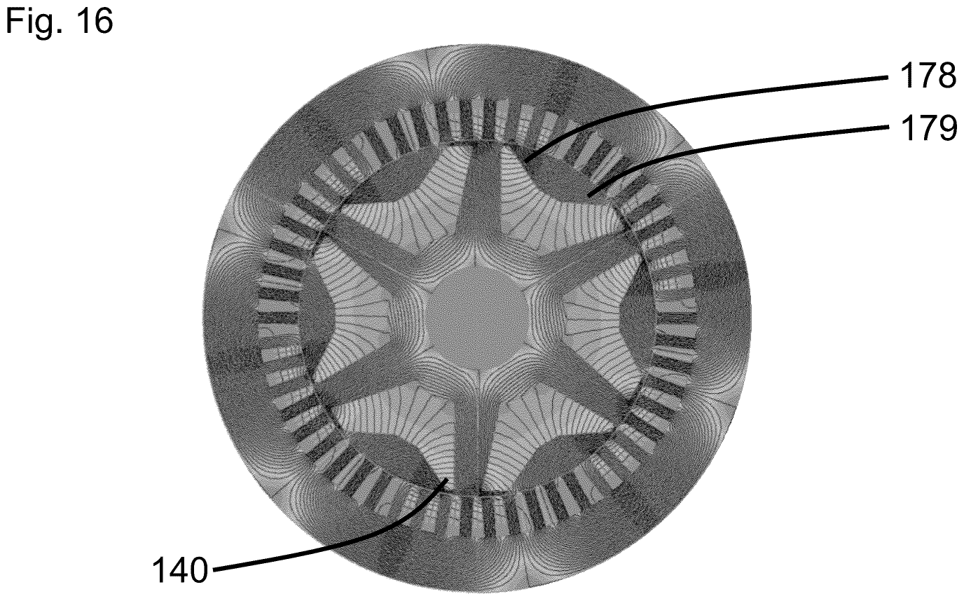

FIG. 16 is a contour plot of a Finite Element Analysis (FEA) of a non-gap-pole, synchronous-reluctance, rotary motor-generator with non-symmetric lamination geometry under a torque load. A high flux density location 178 and a low flux density location 179 show that the flux density is non-symmetric.

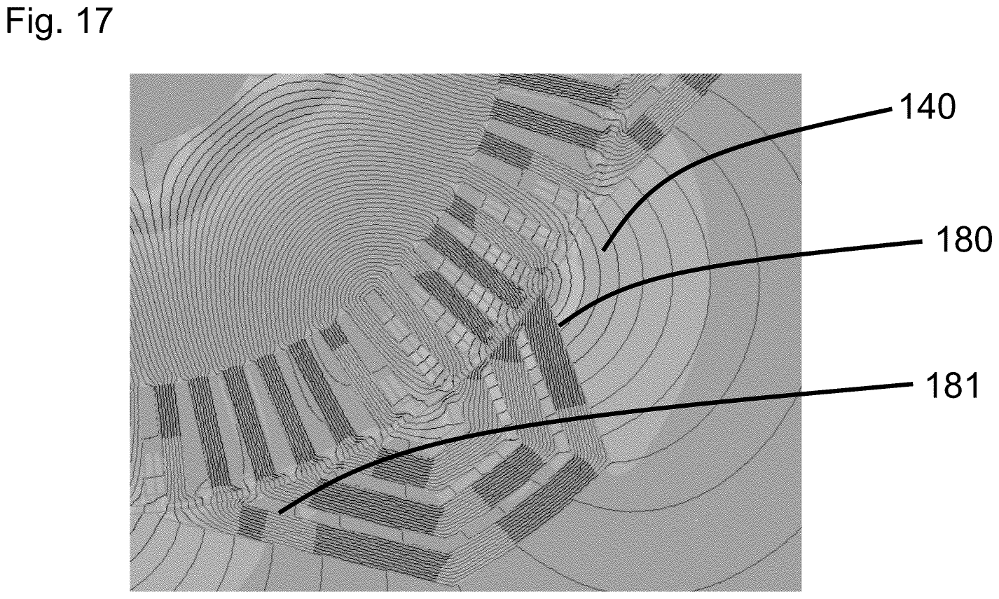

FIG. 17 is a portion of an end section view contour plot of a Finite Element Analysis (FEA) of a gap-pole, synchronous-reluctance, rotary motor-generator with non-symmetric lamination geometry under a torque load. A high flux density location 180 and a low flux density location 181 show that the flux density is non-symmetric. The circumferential non-ferromagnetic gap provides low leakage of magnetic flux from one crescent rotor pole to the adjacent rotor pole as evidenced by the wide spacing of the magnetic flux lines in the gap-pole 140, and this low leakage flux tends to provide a low stator coil inductance and allows for a high power factor, high power density, and high efficiency design.

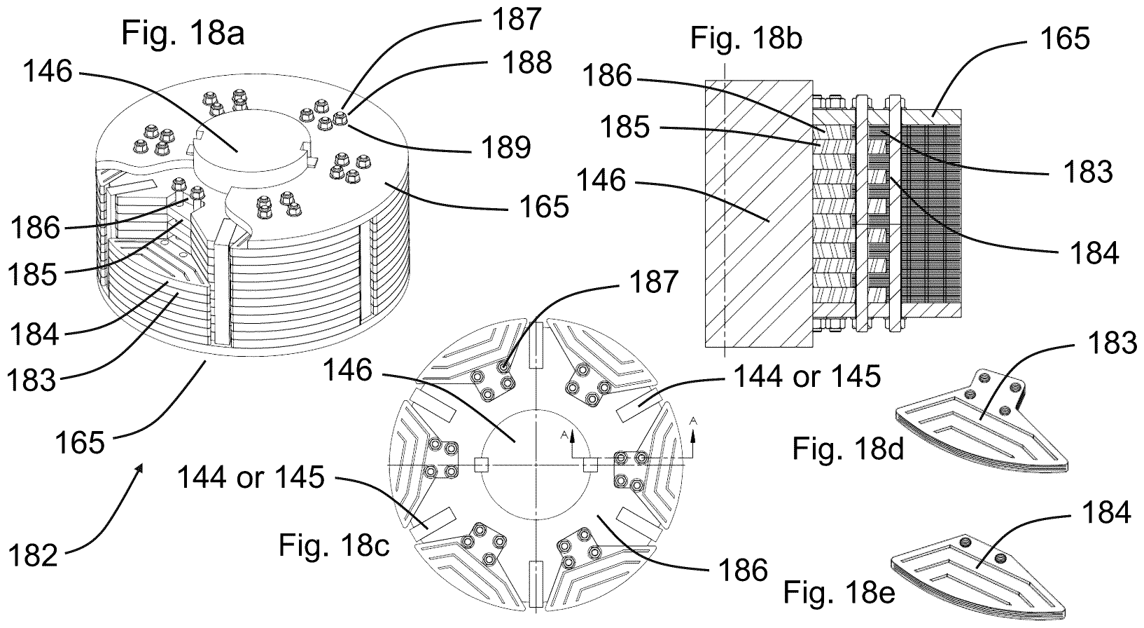

FIG. 18a is an isometric view of an example rotor assembly. FIG. 18b is a sectional view of a portion of the rotor assembly of FIG. 18a, taken along the line indicated in FIG. 18c. FIG. 18c shows a top view of the rotor assembly of FIG. 18a but without the flat, circular end plate. FIG. 18d is an isometric view of an example tabbed crescent-rotor-pole in isolation. FIG. 18e is an isometric view of an example non-tabbed crescent-rotor-pole in isolation.

The rotor assembly 182 of FIGS. 18a to 18e is analogous to the rotor 110 shown in FIG. 8, except that the connections between the ferromagnetic and the non-ferromagnetic rotor elements are different. Accordingly, the rotor assembly 182 of FIG. 18a may be used, for example, in the motor-generator 106 of FIG. 8, and the concepts illustrated in FIGS. 18a-18e and described below can also be applied to the other internal rotor, gap-pole configurations discussed in this disclosure.

FIGS. 18a-18e illustrate an example of how the ferromagnetic laminations of the gap-pole motor-generator rotor can be secured to non-ferromagnetic laminations. Each non-ferromagnetic plates 185 is profiled in a manner to fit with the contour of the tabbed crescent rotor pole 183, and each non-ferromagnetic plates 186 is profiled in a manner to fit with the contour of the crescent rotor pole 184. As illustrated, the tabbed crescent rotor pole 183 has an added retention tab (best shown in FIG. 18d) to fasten or otherwise affix the tabbed crescent rotor pole 183 to the adjacent non-ferromagnetic plate 185. The crescent rotor pole 184 does not have the retention tab (as best shown in FIG. 18e), and the crescent rotor pole 184 is fastened or otherwise affixed to the adjacent, tabbed crescent rotor pole 183.

In the illustrated configuration, the non-ferromagnetic plates 185 and the non-ferromagnetic plates 186 are keyed to the rotating output shaft 146 and joined to the tabbed crescent-rotor-pole 183 and non-tabbed crescent rotor pole assembly 184, such as through bolts 187. The tabbed crescent-rotor-pole 183 and non-tabbed crescent rotor pole assembly 184 are each comprised of bonded ferromagnetic laminations. Non-ferromagnetic, flat, circular end plate 165 is used to clamp the lamination stack together.

In the illustrated configuration, two sizes of crescent rotor pole (namely, the tabbed crescent-rotor-pole 183 and the non-tabbed crescent rotor pole assembly 184) are used to provide a non-magnetic load path through each. The thickness of the tabbed crescent rotor pole assembly 183 and non-tabbed crescent rotor pole assembly 184 may be selected for ease of assembly, to keep the loads on the bolts 187 within allowable limits, and to allow bolts 187, in conjunction with nuts 188 and washers 189, to exert an axial confining compressive load to all the tabbed crescent rotor pole assembly 183 and non-tabbed crescent rotor pole assembly 184. This arrangement serves to prevent loosening or vibration of individual laminations within the tabbed crescent rotor pole assembly 183 and non-tabbed crescent rotor pole assembly 184. This rotor assembly may have slight gaps between the non-ferromagnetic plates 185 and the non-ferromagnetic plates 186, and such gaps may optionally be filled using, for example, a vacuum pressure impregnation (VPI) process. As described elsewhere in this specification in conjunction with FIG. 4 and others, permanent magnets 144 may be incorporated between the crescent rotor poles 128.

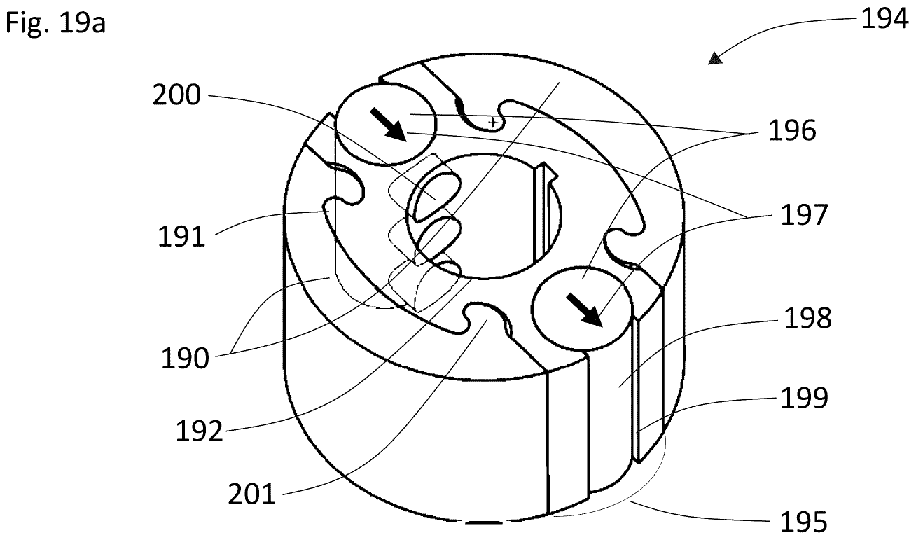

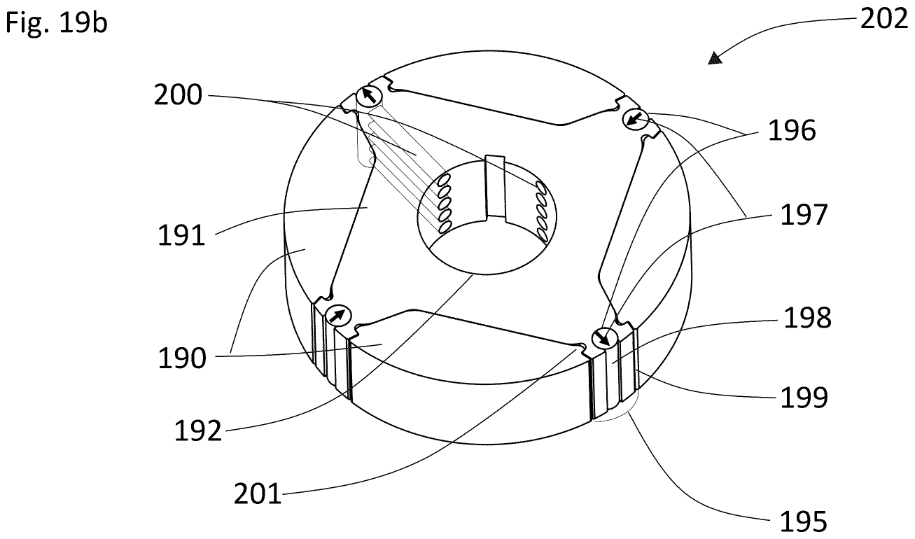

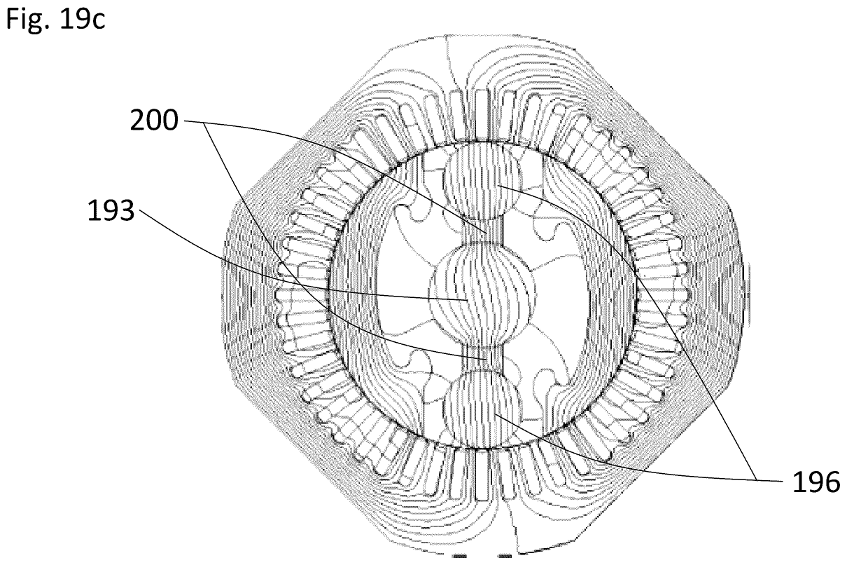

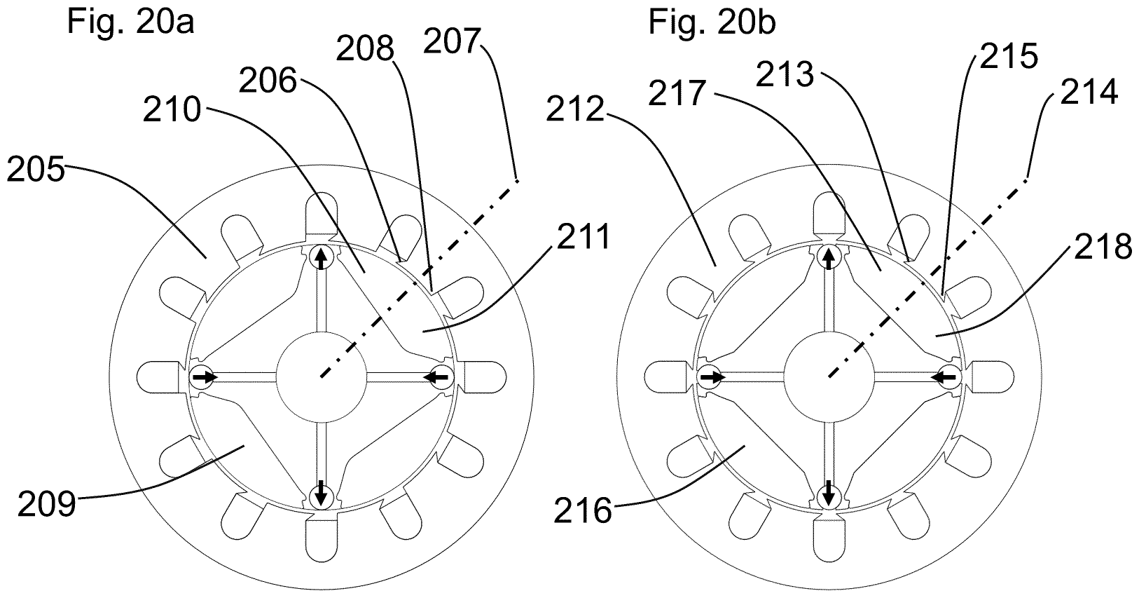

FIG. 19a is an isometric view showing portions of a two-pole gap-pole rotor assembly, according to an example configuration. FIG. 19c is a magnetic flux plot of the two-pole gap-pole rotor assembly of FIG. 19a. As illustrated in FIGS. 19a and 19c, each rotor of the two-pole gap-pole rotor assembly 194 has an even number of laminated ferromagnetic poles 190 (there are two illustrated in FIG. 19a) and a non-ferromagnetic rotor portion 191. In configurations, the laminated ferromagnetic poles 190 have no radial lines of symmetry, such as illustrated in FIG. 19a. In other configurations, the laminated ferromagnetic poles 190 have at least one radial line of symmetry, such as illustrated (for a four-pole gap-pole rotor assembly) in FIG. 20b. The non-ferromagnetic rotor portion 191 includes a motor shaft bore 192 to accept the motor shaft 193, which is analogous to the rotating output shaft 146 illustrated in FIGS. 7-10.

As illustrated in FIGS. 19a and 19c, the rotor assembly 194 also includes an even number of gap poles 195 (there are two illustrated in FIG. 19a), each having a permanent magnet 196 located in it. Each permanent magnet 196 is magnetized radially or substantially radially and in a manner where adjacent magnets have their magnetic orientation vector 197 oriented in the opposite radial direction or substantially opposite radial direction. In this context, “substantially radially” means in a direction that is tilted less than ten degrees From the radial direction. Likewise, in this context “substantially opposite radial direction” means in a direction that is tilted less than ten degrees From the opposite radial direction.

In configurations, the permanent magnets 196 are position on the rotor assembly 194 to be substantially tangential to the outside diameter of the rotor assembly 194 at the location 198. As used in this context, “substantially tangential” means largely or essentially meeting the curve (in this case, the outside diameter of the rotor assembly) at a single point, with the understanding that the “point” may be a small arc since both surfaces are curved. The part of the non-ferromagnetic rotor portion 191 that is absent to accommodate the permanent magnets 196 may include an opening 199 in the outside diameter to simplify manufacturing. In configurations, several ferromagnetic inserts 200 may be located in the rotor assembly 194 in a radial orientation between each permanent magnet 196 and the motor shaft bore 192 to conduct magnetic flux from each permanent magnet 196 to the other permanent magnets 196 by using a ferromagnetic shaft that is fitted into motor shaft bore 192 to provide ferromagnetic flux paths connecting all ferromagnetic inserts 200. The non-ferromagnetic rotor portion 191 may also be integrated with a motor shaft, forming a single mechanical body and with the ferromagnetic inserts 200 of appropriate design to provide ferromagnetic flux paths up to the rotor centerline in order to pass magnetic flux between the permanent magnets 196. Protrusion 201 of the laminated ferromagnetic pole 190 is one possible retention method for coupling the laminated ferromagnetic pole 190 to the non-ferromagnetic rotor portion 191. Non-ferromagnetic rotor portion 191 may be made from high resistivity material or laminated material to minimize eddy current losses.

FIG. 19b is an isometric view showing portions of a four-pole gap-pole rotor assembly 202, according to an example configuration. Except for having four poles instead of two poles, the discussion above for the gap-pole rotor assembly 194 of FIG. 19a applies to the gap-pole rotor assembly 202 of FIG. 19b, too.

The rotor low-reluctance D-axes for the rotor assembly 194 of FIG. 19a and the rotor assembly 202 of FIG. 19b pass through the laminated ferromagnetic poles 190. Accordingly, the configurations illustrated in FIGS. 19a and 19b are examples of gap-pole configurations.

The rotor assembly 194 of FIG. 19a can be used in the other two-gap-pole, internal rotor configurations included in this disclosure, including the configurations illustrated in FIG. 10. The rotor assembly 202 of FIG. 19b can be used in the other four-gap-pole, internal rotor configurations included in this disclosure, including the configurations illustrated in FIGS. 9 and 20.

FIG. 20a is a sectional end view of an example gap-pole, non-symmetric, internal rotor, axial magnet motor-generator, which is similar to what is illustrated in FIG. 9. As a result, the motor-generator of FIG. 20a has the same features and components as the motor-generator 107 of FIG. 9. Hence, the above discussion for the motor-generator 107 of FIG. 9 applies also to the motor-generator of FIG. 20a, although the motor-generator of FIG. 20a uses different reference numbers for some components. For ease of comparing the motor-generator of FIG. 20a to the motor-generator of FIG. 20b, however, some features have not been illustrated or marked with a reference number.

As illustrated in FIG. 20a, a stator salient pole 205 has a stator-salient-pole tab 206 located on one side of a centerline 207 and a corner 208 on the other side of centerline 207. Hence, the stator salient pole 205 is non-symmetrical across the centerline 207. Similarly, a crescent rotor pole 209 has a radially thin side 210 on one side of the centerline 207 and a radially thick side 211 on the other side of centerline 207. Hence, the crescent rotor pole 209 is non-symmetrical across the centerline 207, and centerline 207 is not a line of symmetry of the crescent rotor pole 209.

FIG. 20b is a sectional end view of an example gap-pole, symmetric, internal rotor, axial magnet motor-generator having symmetrical stator salient poles and symmetrical crescent rotor poles. As illustrated in FIG. 20b, a stator salient pole 212 has a stator-salient-pole tab 213 located on one side of a centerline 214 and a similar stator-salient-pole tab 215 located on another side of the centerline 214. Hence, the stator salient pole 212 is symmetrical across the centerline 214. Similarly, a crescent rotor pole 216 has a radial thickness at location 217 on one side of the centerline 214 that is equal to the radial thickness at location 218 on the other side of centerline 214. Hence, the crescent rotor pole 216 is symmetrical across the centerline 214, and centerline 214 is a line of symmetry of the crescent rotor pole 216.

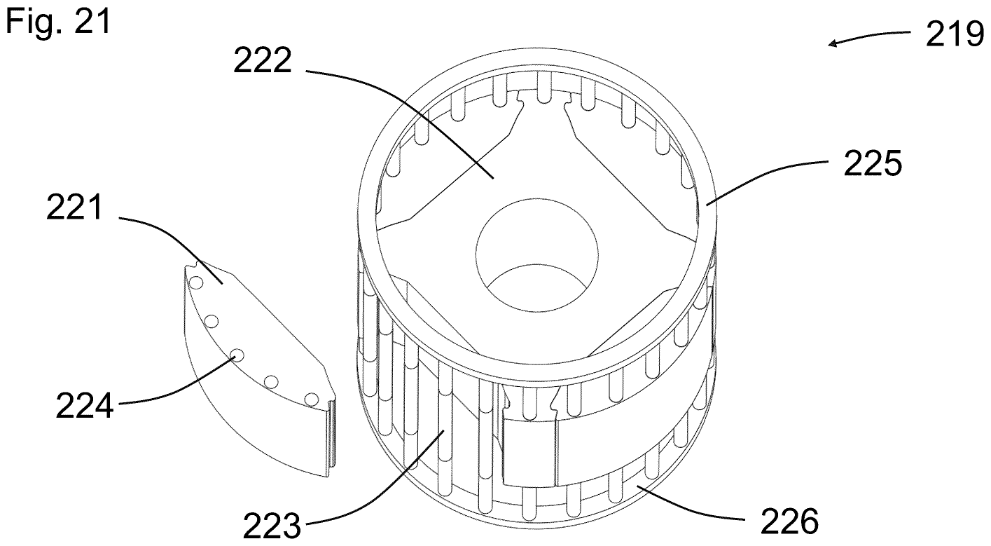

FIG. 21 is an isometric view of an example gap-pole, symmetric, internal rotor, motor-generator rotor with conductive bars. The gap-pole rotor 219 has a pattern of axial holes 224 drilled through the crescent rotor poles 221 and the non-ferromagnetic rotor portion 222. A conductive bar 223 is inserted in each of the holes 224. One end of each of the conductive bars 223 is joined in an electrically conductive manner to a conductive ring 225. The other end of each of the conductive bars 223 is joined in an electrically conductive manner to another conductive ring 226. Adding the conductive bars 223 and conductive rings 225 and 226 to the gap-pole rotor 219 allows the gap pole motor to perform in a manner similar to a standard, previously existing induction motor to help in operation to accelerate the rotor from zero rotational speed to a point that is near to the operating synchronous speed and to help dampen the motor rotational speed to maintain a constant isochronous rotational speed.

### EXAMPLES

Illustrative examples of the disclosed technologies are provided below. A particular configuration of the technologies may include one or more, and any combination of, the examples described below.

Example 1 includes a synchronous-reluctance, rotary motor-generator comprising: a rotor having a rotor-volume envelope that is substantially cylindrical, a plurality of rotor slots, a rotor salient pole between each rotor slot of the plurality of rotor slots, each rotor salient pole having no radial line of symmetry and having a radially-oriented centerline of the rotor salient pole, and a crescent rotor pole within each rotor slot of the plurality of rotor slots, adjacent crescent rotor poles being non-symmetric about the centerline of the rotor salient pole that passes between the adjacent crescent rotor poles, each crescent rotor pole having no radial line of symmetry, in which each low-reluctance direct axis of the rotor passes through at least one of the rotor salient poles; a stator having a stator-volume envelope that is substantially cylindrical, the stator being on a common center with the rotor; a radial air gap positioned radially between the stator and the rotor, each crescent rotor pole being positioned tangentially to the radial air gap; and a conductor winding assembly held by the stator and having a plurality of individual conductor winding coils, each individual conductor winding coil of the plurality of individual conductor winding coils being in one or more coil winding slots of a plurality of coil winding slots of the stator, a stator salient pole of the stator being between each coil winding slot of the plurality of coil winding slots and positioned tangentially to the radial air gap, each stator salient pole having no radial line of symmetry, each rotor slot of the plurality of rotor slots being positioned tangentially to the radial air gap.

Example 2 includes the synchronous-reluctance, rotary motor-generator of Example 1, the stator comprising ferromagnetic laminations, and the rotor comprising ferromagnetic laminations affixed to non-ferromagnetic laminations.

Example 3 includes the synchronous-reluctance, rotary motor-generator of any of Examples 1-2, further comprising a permanent magnet positioned between each rotor salient pole and an adjacent crescent rotor pole.

Example 4 includes the synchronous-reluctance, rotary motor-generator of Example 3, in which adjacent permanent magnets are magnetized in opposite circumferential directions of the synchronous-reluctance, rotary motor-generator.

Example 5 includes the synchronous-reluctance, rotary motor-generator of Example 3, in which adjacent permanent magnets are magnetized in opposite radial directions.

Example 6 includes the synchronous-reluctance, rotary motor-generator of any of Examples 1-2, further comprising an electromagnetic coil positioned between each rotor salient pole and an adjacent crescent rotor pole.

Example 7 includes the synchronous-reluctance, rotary motor-generator of any of Examples 1-6, in which the rotor is radially external to the stator.

Example 8 includes the synchronous-reluctance, rotary motor-generator of any of Examples 1-6, in which the rotor is radially internal to the stator.

Example 9 includes a synchronous-reluctance, rotary motor-generator comprising: a rotor having a rotor-volume envelope that is substantially cylindrical and an even number of crescent rotor poles with a gap between adjacent crescent rotor poles, each crescent rotor pole having no radial line of symmetry, in which each low-reluctance direct axis of the rotor passes through at least one of the gaps between the crescent rotor poles; a stator having a stator-volume envelope that is substantially cylindrical, the stator being on a common center with the rotor; a radial air gap positioned radially between the stator and the rotor, each crescent rotor pole being positioned tangentially to the radial air gap; and a conductor winding assembly held by the stator and having a plurality of individual conductor winding coils, each individual conductor winding coil of the plurality of individual conductor winding coils being in one or more coil winding slots of a plurality of coil winding slots of the stator, a stator salient pole of the stator being between each coil winding slot of the plurality of coil winding slots and positioned tangentially to the radial air gap, each stator salient pole having no radial line of symmetry.

Example 10 includes the synchronous-reluctance, rotary motor-generator of Example 9, further comprising a permanent magnet positioned in each of the gaps between the crescent rotor poles, each permanent magnet being magnetized in a circumferential direction of the synchronous-reluctance, rotary motor-generator.

Example 11 includes the synchronous-reluctance, rotary motor-generator of Example 9, further comprising a permanent magnet positioned in each of the gaps between the crescent rotor poles, each permanent magnet being magnetized in a radial direction.

Example 12 includes the synchronous-reluctance, rotary motor-generator of Example 9, further comprising an electromagnetic coil positioned in each of the gaps between the crescent rotor poles.

Example 13 includes the synchronous-reluctance, rotary motor-generator of any of Examples 9-12, the crescent rotor pole comprising lamination having a grain direction, the grain direction of the lamination being oriented in a circumferential direction of the synchronous-reluctance, rotary motor-generator.

Example 14 includes the synchronous-reluctance, rotary motor-generator of any of Examples 9-13, in which the rotor is radially external to the stator.

Example 15 includes the synchronous-reluctance, rotary motor-generator of Example 14, in which the even number of crescent rotor poles is two crescent rotor poles.

Example 16 includes the synchronous-reluctance, rotary motor-generator of Example 14, in which the even number of crescent rotor poles is four crescent rotor poles.

Example 17 includes the synchronous-reluctance, rotary motor-generator of Example 14, in which the even number of crescent rotor poles is six crescent rotor poles.

Example 18 includes the synchronous-reluctance, rotary motor-generator of any of Examples 9-13, in which the rotor is radially internal to the stator.

Example 19 includes the synchronous-reluctance, rotary motor-generator of Example 18, in which the even number of crescent rotor poles is two crescent rotor poles.

Example 20 includes the synchronous-reluctance, rotary motor-generator of Example 18, in which the even number of crescent rotor poles is four crescent rotor poles.

Example 21 includes the synchronous-reluctance, rotary motor-generator of Example 18, in which the even number of crescent rotor poles is six crescent rotor poles.

Example 22 includes the synchronous-reluctance, rotary motor-generator of any of Examples 9-21, the stator comprising ferromagnetic laminations, and the rotor comprising ferromagnetic laminations affixed to non-ferromagnetic laminations in a lamination plane.

Example 23 includes the synchronous-reluctance, rotary motor-generator of Example 22, in which each of the non-ferromagnetic laminations of the rotor include a deep-drawn deformation out of the lamination plane, in which each of the ferromagnetic laminations of the rotor include a deep-drawn deformation out of the lamination plane, in which the deformation of the non-ferromagnetic laminations of the rotor is configured to nest with the deformation of the ferromagnetic laminations of the rotor.

Example 24 includes the synchronous-reluctance, rotary motor-generator of Example 23, further comprising a through hole through the deformation of the non-ferromagnetic laminations of the rotor and a through hole through the deformation of the ferromagnetic laminations of the rotor.

Example 25 includes a synchronous-reluctance, rotary motor-generator comprising: a rotor having a rotor-volume envelope that is substantially cylindrical and an even number of crescent rotor poles with a gap between adjacent crescent rotor poles, each crescent rotor pole being symmetric about a radially-oriented centerline of the rotor ferromagnetic flux path, in which each low-reluctance direct axis of the rotor passes through at least one of the gaps between the crescent rotor poles; a stator having a stator-volume envelope that is substantially cylindrical, the stator being on a common center with the rotor; a radial air gap positioned radially between the stator and the rotor, each crescent rotor pole being positioned tangentially to the radial air gap; and a conductor winding assembly held by the stator and having a plurality of individual conductor winding coils, each individual conductor winding coil of the plurality of individual conductor winding coils being in one or more coil winding slots of a plurality of coil winding slots of the stator, a stator salient pole of the stator being between each coil winding slot of the plurality of coil winding slots and positioned tangentially to the radial air gap, each stator salient pole being symmetric about a radially-oriented centerline of the stator-salient-pole.

Example 26 includes the synchronous-reluctance, rotary motor-generator of Example 25, further comprising a permanent magnet positioned in each of the gaps between the crescent rotor poles.

Example 27 includes the synchronous-reluctance, rotary motor-generator of any of Examples 25-26, the crescent rotor pole comprising lamination having a grain direction, the grain direction of the lamination being oriented in a circumferential direction of the synchronous-reluctance, rotary motor-generator.

Example 28 includes the synchronous-reluctance, rotary motor-generator of any of Examples 25-27, the rotor further comprising a non-ferromagnetic rotor portion, the non-ferromagnetic rotor portion and the crescent rotor poles having a plurality of conductive bars extending axially through the non-ferromagnetic rotor portion and the crescent rotor poles.

Example 29 includes the synchronous-reluctance, rotary motor-generator of any of Examples 25-28, the stator comprising ferromagnetic laminations, and the rotor comprising ferromagnetic laminations affixed to non-ferromagnetic laminations in a lamination plane.

Example 30 includes the synchronous-reluctance, rotary motor-generator of Example 29, in which each of the non-ferromagnetic laminations of the rotor include a deep-drawn deformation out of the lamination plane, in which each of the ferromagnetic laminations of the rotor include a deep-drawn deformation out of the lamination plane, in which the deformation of the non-ferromagnetic laminations of the rotor is configured to nest with the deformation of the ferromagnetic laminations of the rotor.

Example 31 includes the synchronous-reluctance, rotary motor-generator of Example 30, further comprising a through hole through the deformation of the non-ferromagnetic laminations of the rotor and a through hole through the deformation of the ferromagnetic laminations of the rotor.

Example 32 includes a synchronous-reluctance, rotary motor-generator comprising: a rotor having a rotor-volume envelope that is substantially cylindrical and an even number of crescent rotor poles with a gap between adjacent crescent rotor poles, each crescent rotor pole having no radial line of symmetry, in which each low-reluctance direct axis of the rotor passes through at least one of the gaps between the crescent rotor poles; a stator having a stator-volume envelope that is substantially cylindrical, the stator being on a common center with the rotor; an axial air gap positioned axially between the stator and the rotor, each crescent rotor pole being positioned tangentially to the radial air gap; and a conductor winding assembly held by the stator and having a plurality of individual conductor winding coils, each individual conductor winding coil of the plurality of individual conductor winding coils being in one or more coil winding slots of a plurality of coil winding slots of the stator, a stator salient pole of the stator being between each coil winding slot of the plurality of coil winding slots and positioned adjacent to the radial air gap, each stator salient pole having no radial line of symmetry.

Example 33 includes the synchronous-reluctance, rotary motor-generator of Example 32, further comprising a permanent magnet positioned in each of the gaps between the crescent rotor poles, each permanent magnet being magnetized in a circumferential direction of the synchronous-reluctance, rotary motor-generator.

Example 34 includes the synchronous-reluctance, rotary motor-generator of Example 32, further comprising an electromagnetic coil positioned in each of the gaps between the crescent rotor poles.

Example 35 includes the synchronous-reluctance, rotary motor-generator of any of Examples 32-34, the crescent rotor pole comprising lamination having a grain direction, the grain direction of the lamination being oriented in a circumferential direction of the synchronous-reluctance, rotary motor-generator.

Example 36 includes a synchronous-reluctance, rotary motor-generator comprising: a rotor having a rotor-volume envelope that is substantially cylindrical and an even number of laminated ferromagnetic poles and a non-ferromagnetic portion between the laminated ferromagnetic poles, in which each low-reluctance direct axis of the rotor passes through the non-ferromagnetic portion; a stator having a stator-volume envelope that is substantially cylindrical, the stator being on a common center with the rotor, the common center passing through a motor-shaft bore of the rotor; a radial air gap positioned radially between the stator and the rotor, each laminated ferromagnetic pole being positioned tangentially to the radial air gap; a conductor winding assembly held by the stator and having a plurality of individual conductor winding coils, each individual conductor winding coil of the plurality of individual conductor winding coils being in one or more coil winding slots of a plurality of coil winding slots of the stator, a stator salient pole of the stator being between each coil winding slot of the plurality of coil winding slots and positioned tangentially to the radial air gap; and a plurality of permanent magnets within the non-ferromagnetic portion of the rotor and substantially tangential to an outside diameter of the rotor, each permanent magnet of the plurality of permanent magnets being magnetized substantially radially.

Example 37 includes the synchronous-reluctance, rotary motor-generator of Example 36, in which each stator salient pole has no radial line of symmetry.

Example 38 includes the synchronous-reluctance, rotary motor-generator of Example 36, in which each stator salient pole has a radial line of symmetry.

Example 39 includes the synchronous-reluctance, rotary motor-generator of any of Examples 36-38, in which adjacent permanent magnets have magnetic orientation vectors oriented in substantially opposite radial directions.

Example 40 includes the synchronous-reluctance, rotary motor-generator of any of Examples 36-39, in which the non-ferromagnetic portion of the rotor includes one or more ferromagnetic inserts oriented radially between each permanent magnet of the plurality of permanent magnets and the motor-shaft bore of the rotor.

Example 41 includes the synchronous-reluctance, rotary motor-generator of any of Examples 36-40, in which the even number of laminated ferromagnetic poles is two laminated ferromagnetic poles.

Example 42 includes the synchronous-reluctance, rotary motor-generator of any of Examples 36-40, in which the even number of laminated ferromagnetic poles is four laminated ferromagnetic poles.

Example 43 includes the synchronous-reluctance, rotary motor-generator of any of Examples 36-42, in which each laminated ferromagnetic pole has no radial line of symmetry.

Example 44 includes the synchronous-reluctance, rotary motor-generator of any of Examples 36-42, in which each laminated ferromagnetic pole has at least one radial line of symmetry.

Example 45 includes the synchronous-reluctance, rotary motor-generator of any of Examples 36-44, the stator comprising ferromagnetic laminations, and the rotor comprising ferromagnetic laminations affixed to non-ferromagnetic laminations in a lamination plane.

Example 46 includes the synchronous-reluctance, rotary motor-generator of Example 45, in which each of the non-ferromagnetic laminations of the rotor include a deep-drawn deformation out of the lamination plane, in which each of the ferromagnetic laminations of the rotor include a deep-drawn deformation out of the lamination plane, in which the deformation of the non-ferromagnetic laminations of the rotor is configured to nest with the deformation of the ferromagnetic laminations of the rotor.

Example 47 includes the synchronous-reluctance, rotary motor-generator of Example 46, further comprising a through hole through the deformation of the non-ferromagnetic laminations of the rotor and a through hole through the deformation of the ferromagnetic laminations of the rotor.

The contents of the present document have been presented for purposes of illustration and description, but such contents are not intended to be exhaustive or limited to the disclosure in the form disclosed. Many modifications and variations will be apparent to those of ordinary skill in the art without departing from the scope and spirit of the disclosure. The aspects of the disclosure in this document were chosen and described to explain the principles of the disclosure and the practical application, and to enable others of ordinary skill in the art to understand the disclosure with various modifications as are suited to the particular use contemplated.

For example, the use of the term motor-generator applies to the disclosed technology when used as a combination motor-generator, when used only as a motor, and also when used only as a generator. The end section views in the various figures can be used for a variety of motor-generator lengths, with the motor-generator length measured perpendicular to the end section view. The disclosed technology is suitable for a variety of motor-generator sizes and for a variety of motor-generator length/diameter aspect ratios.

Accordingly, it is to be understood that the disclosure in this specification includes all possible combinations of the particular features referred to in this specification. For example, where a particular feature is disclosed in the context of a particular example configuration, that feature can also be used, to the extent possible, in the context of other example configurations.

Additionally, the described versions of the disclosed subject matter have many advantages that were either described or would be apparent to a person of ordinary skill. Even so, all of these advantages or features are not required in all versions of the disclosed apparatus, systems, or methods.

Also, when reference is made in this application to a method having two or more defined steps or operations, the defined steps or operations can be carried out in any order or simultaneously, unless the context excludes those possibilities.

The terminology used in this specification is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof. Hence, for example, an article “comprising” or “which comprises” components A, B, and C can contain only components A, B, and C, or it can contain components A, B, and C along with one or more other components.

Also, directions such as “clockwise,” “counterclockwise,” “vertical,” “horizontal,” “right,” and “left” are used for convenience and in reference to the views provided in figures. But the rotor-generator may have a number of orientations in actual use. Thus, a feature that is vertical, horizontal, to the right, or to the left in the figures may not have that same orientation or direction in actual use.

It is understood that the present subject matter may be embodied in many different forms and should not be construed as being limited to the example configurations set forth in this specification. Rather, these example configurations are provided so that this subject matter will be thorough and complete and will convey the disclosure to those skilled in the art. Indeed, the subject matter is intended to cover alternatives, modifications, and equivalents of these example configurations, which are included within the scope and spirit of the subject matter set forth in this disclosure. Furthermore, in the detailed description of the present subject matter, specific details are set forth to provide a thorough understanding of the present subject matter. It will be clear to those of ordinary skill in the art, however, that the present subject matter may be practiced without such specific details.

I/We claim:

1. A synchronous-reluctance, rotary motor-generator comprising:
a rotor having a rotor-volume envelope that is substantially cylindrical, a plurality of rotor slots, a rotor salient pole between each rotor slot of the plurality of rotor slots, each rotor salient pole having no radial line of symmetry and having a radially-oriented centerline of the rotor salient pole, and a crescent rotor pole within each rotor slot of the plurality of rotor slots, adjacent crescent rotor poles being non-symmetric about the centerline of the rotor salient pole that passes between the adjacent crescent rotor poles, each crescent rotor pole having no radial line of symmetry, in which each low-reluctance direct axis of the rotor passes through at least one of the rotor salient poles;
a stator having a stator-volume envelope that is substantially cylindrical, the stator being on a common center with the rotor;
a radial air gap positioned radially between the stator and the rotor, each crescent rotor pole being positioned tangentially to the radial air gap; and
a conductor winding assembly held by the stator and having a plurality of individual conductor winding coils, each individual conductor winding coil of the plurality of individual conductor winding coils being in one or more coil winding slots of a plurality of coil winding slots of the stator, a stator salient pole of the stator being between each coil winding slot of the plurality of coil winding slots and positioned tangentially to the radial air gap, each stator salient pole having no radial line of symmetry, each rotor slot of the plurality of rotor slots being positioned tangentially to the radial air gap.

2. The synchronous-reluctance, rotary motor-generator of claim 1, the stator comprising ferromagnetic laminations, and the rotor comprising ferromagnetic laminations affixed to non-ferromagnetic laminations.

3. The synchronous-reluctance, rotary motor-generator of claim 1, further comprising a permanent magnet positioned between each rotor salient pole and an adjacent crescent rotor pole.

4. The synchronous-reluctance, rotary motor-generator of claim 3, in which adjacent permanent magnets are magnetized in opposite circumferential directions of the synchronous-reluctance, rotary motor-generator.

5. The synchronous-reluctance, rotary motor-generator of claim 3, in which adjacent permanent magnets are magnetized in opposite radial directions.

6. The synchronous-reluctance, rotary motor-generator of claim 1, further comprising an electromagnetic coil positioned between each rotor salient pole and an adjacent crescent rotor pole.

7. The synchronous-reluctance, rotary motor-generator of claim 1, in which the rotor is radially external to the stator.

8. The synchronous-reluctance, rotary motor-generator of claim 1, in which the rotor is radially internal to the stator.

9. A synchronous-reluctance, rotary motor-generator comprising:
a rotor having a rotor-volume envelope that is substantially cylindrical and an even number of crescent rotor poles with a gap between adjacent crescent rotor poles, each crescent rotor pole having no radial line of symmetry, in which each low-reluctance direct axis of the rotor passes through at least one of the gaps between the crescent rotor poles;
a stator having a stator-volume envelope that is substantially cylindrical, the stator being on a common center with the rotor;
a radial air gap positioned radially between the stator and the rotor, each crescent rotor pole being positioned tangentially to the radial air gap; and
a conductor winding assembly held by the stator and having a plurality of individual conductor winding coils, each individual conductor winding coil of the plurality of individual conductor winding coils being in one or more coil winding slots of a plurality of coil winding slots of the stator, a stator salient pole of the stator being between each coil winding slot of the plurality of coil winding slots and positioned tangentially to the radial air gap, each stator salient pole having no radial line of symmetry.

10. The synchronous-reluctance, rotary motor-generator of claim 9, further comprising a permanent magnet positioned in each of the gaps between the crescent rotor poles, each permanent magnet being magnetized in a circumferential direction of the synchronous-reluctance, rotary motor-generator.

11. The synchronous-reluctance, rotary motor-generator of claim 9, further comprising a permanent magnet positioned in each of the gaps between the crescent rotor poles, each permanent magnet being magnetized in a radial direction.

12. The synchronous-reluctance, rotary motor-generator of claim 9, further comprising an electromagnetic coil positioned in each of the gaps between the crescent rotor poles.

13. The synchronous-reluctance, rotary motor-generator of claim 9, the crescent rotor pole comprising lamination having a grain direction, the grain direction of the lamination being oriented in a circumferential direction of the synchronous-reluctance, rotary motor-generator.

14. The synchronous-reluctance, rotary motor-generator of claim 9, in which the rotor is radially external to the stator.

15. The synchronous-reluctance, rotary motor-generator of claim 9, in which the rotor is radially internal to the stator.

16. The synchronous-reluctance, rotary motor-generator of claim 9, the stator comprising ferromagnetic laminations, and the rotor comprising ferromagnetic laminations affixed to non-ferromagnetic laminations in a lamination plane.

17. The synchronous-reluctance, rotary motor-generator of claim 16, in which each of the non-ferromagnetic laminations of the rotor include a deep-drawn deformation out of the lamination plane, in which each of the ferromagnetic laminations of the rotor include a deep-drawn deformation out of the lamination plane, in which the deformation of the non-ferromagnetic laminations of the rotor is configured to nest with the deformation of the ferromagnetic laminations of the rotor.

18. The synchronous-reluctance, rotary motor-generator of claim 17, further comprising a through hole through the deformation of the non-ferromagnetic laminations of the rotor and a through hole through the deformation of the ferromagnetic laminations of the rotor.

19. A synchronous-reluctance, rotary motor-generator comprising:
a rotor having a rotor-volume envelope that is substantially cylindrical and an even number of crescent rotor poles with a gap between adjacent crescent rotor poles, each crescent rotor pole being symmetric about a radially-oriented centerline of the rotor ferromagnetic flux path, in which each low-reluctance direct axis of the rotor passes through at least one of the gaps between the crescent rotor poles;
a stator having a stator-volume envelope that is substantially cylindrical, the stator being on a common center with the rotor;
a radial air gap positioned radially between the stator and the rotor, each crescent rotor pole being positioned tangentially to the radial air gap; and
a conductor winding assembly held by the stator and having a plurality of individual conductor winding coils, each individual conductor winding coil of the plurality of individual conductor winding coils being in one or more coil winding slots of a plurality of coil winding slots of the stator, a stator salient pole of the stator being between each coil winding slot of the plurality of coil winding slots and positioned tangentially to the radial air gap, each stator salient pole being symmetric about a radially-oriented centerline of the stator-salient-pole.

20. The synchronous-reluctance, rotary motor-generator of claim 19, further comprising a permanent magnet positioned in each of the gaps between the crescent rotor poles.

21. The synchronous-reluctance, rotary motor-generator of claim 19, the crescent rotor pole comprising lamination having a grain direction, the grain direction of the lamination being oriented in a circumferential direction of the synchronous-reluctance, rotary motor-generator.

22. The synchronous-reluctance, rotary motor-generator of claim 19, the rotor further comprising a non-ferromagnetic rotor portion, the non-ferromagnetic rotor portion and the crescent rotor poles having a plurality of conductive bars extending axially through the non-ferromagnetic rotor portion and the crescent rotor poles.

23. The synchronous-reluctance, rotary motor-generator of claim 19, the stator comprising ferromagnetic laminations, and the rotor comprising ferromagnetic laminations affixed to non-ferromagnetic laminations in a lamination plane.

24. The synchronous-reluctance, rotary motor-generator of claim 23, in which each of the non-ferromagnetic laminations of the rotor include a deep-drawn deformation out of the lamination plane, in which each of the ferromagnetic laminations of the rotor include a deep-drawn deformation out of the lamination plane, in which the deformation of the non-ferromagnetic laminations of the rotor is configured to nest with the deformation of the ferromagnetic laminations of the rotor.

25. The synchronous-reluctance, rotary motor-generator of claim 24, further comprising a through hole through the deformation of the non-ferromagnetic laminations of the rotor and a through hole through the deformation of the ferromagnetic laminations of the rotor.

26. A synchronous-reluctance, rotary motor-generator comprising:
a rotor having a rotor-volume envelope that is substantially cylindrical and an even number of crescent rotor poles with a gap between adjacent crescent rotor poles, each crescent rotor pole having no radial line of symmetry, in which each low-reluctance direct axis of the rotor passes through at least one of the gaps between the crescent rotor poles;
a stator having a stator-volume envelope that is substantially cylindrical, the stator being on a common center with the rotor;
an axial air gap positioned axially between the stator and the rotor, each crescent rotor pole being positioned tangentially to the radial air gap; and
a conductor winding assembly held by the stator and having a plurality of individual conductor winding coils, each individual conductor winding coil of the plurality of individual conductor winding coils being in one or more coil winding slots of a plurality of coil winding slots of the stator, a stator salient pole of the stator being between each coil winding slot of the plurality of coil winding slots and positioned adjacent to the radial air gap, each stator salient pole having no radial line of symmetry.

27. The synchronous-reluctance, rotary motor-generator of claim 26, further comprising a permanent magnet positioned in each of the gaps between the crescent rotor poles, each permanent magnet being magnetized in a circumferential direction of the synchronous-reluctance, rotary motor-generator.

28. The synchronous-reluctance, rotary motor-generator of claim 26, further comprising an electromagnetic coil positioned in each of the gaps between the crescent rotor poles.

29. The synchronous-reluctance, rotary motor-generator of claim 26, the crescent rotor pole comprising lamination having a grain direction, the grain direction of the lamination being oriented in a circumferential direction of the synchronous-reluctance, rotary motor-generator.

30. A synchronous-reluctance, rotary motor-generator comprising:
a rotor having a rotor-volume envelope that is substantially cylindrical and an even number of laminated ferromagnetic poles and a non-ferromagnetic portion between the laminated ferromagnetic poles, in which each low-reluctance direct axis of the rotor passes through the non-ferromagnetic portion;
a stator having a stator-volume envelope that is substantially cylindrical, the stator being on a common center with the rotor, the common center passing through a motor-shaft bore of the rotor;
a radial air gap positioned radially between the stator and the rotor, each laminated ferromagnetic pole being positioned tangentially to the radial air gap;
a conductor winding assembly held by the stator and having a plurality of individual conductor winding coils, each individual conductor winding coil of the plurality of individual conductor winding coils being in one or more coil winding slots of a plurality of coil winding slots of the stator, a stator salient pole of the stator being between each coil winding slot of the plurality of coil winding slots and positioned tangentially to the radial air gap; and
a plurality of permanent magnets within the non-ferromagnetic portion of the rotor and substantially tangential to an outside diameter of the rotor, each permanent magnet of the plurality of permanent magnets being magnetized substantially radially.

31. The synchronous-reluctance, rotary motor-generator of claim 30, in which each stator salient pole has no radial line of symmetry.

32. The synchronous-reluctance, rotary motor-generator of claim 30, in which each stator salient pole has a radial line of symmetry.

33. The synchronous-reluctance, rotary motor-generator of claim 30, in which adjacent permanent magnets have magnetic orientation vectors oriented in substantially opposite radial directions.

34. The synchronous-reluctance, rotary motor-generator of claim 30, in which the non-ferromagnetic portion of the rotor includes one or more ferromagnetic inserts oriented radially between each permanent magnet of the plurality of permanent magnets and the motor-shaft bore of the rotor.

35. The synchronous-reluctance, rotary motor-generator of claim 30, in which the even number of laminated ferromagnetic poles is two laminated ferromagnetic poles.

36. The synchronous-reluctance, rotary motor-generator of claim 30, in which the even number of laminated ferromagnetic poles is four laminated ferromagnetic poles.

37. The synchronous-reluctance, rotary motor-generator of claim 30, in which each laminated ferromagnetic pole has no radial line of symmetry.

38. The synchronous-reluctance, rotary motor-generator of claim 30, in which each laminated ferromagnetic pole has at least one radial line of symmetry.

39. The synchronous-reluctance, rotary motor-generator of claim 30, the stator comprising ferromagnetic laminations, and the rotor comprising ferromagnetic laminations affixed to non-ferromagnetic laminations in a lamination plane.

40. The synchronous-reluctance, rotary motor-generator of claim 39, in which each of the non-ferromagnetic laminations of the rotor include a deep-drawn deformation out of the lamination plane, in which each of the ferromagnetic laminations of the rotor include a deep-drawn deformation out of the lamination plane, in which the deformation of the non-ferromagnetic laminations of the rotor is configured to nest with the deformation of the ferromagnetic laminations of the rotor.

41. The synchronous-reluctance, rotary motor-generator of claim 40, further comprising a through hole through the deformation of the non-ferromagnetic laminations of the rotor and a through hole through the deformation of the ferromagnetic laminations of the rotor.
